(19) United States
(12) Patent Application Publication
(10) Pub. No.: US 2015/0178361 A1
(43) Pub. Date: Jun. 25, 2015

(54) INFORMATION PROCESSING APPARATUS, INFORMATION PROCESSING TERMINAL, COMPUTER PROGRAM PRODUCT, AND INFORMATION PROCESSING METHOD

(71) Applicant: KABUSHIKI KAISHA TOSHIBA, Tokyo (JP)

(72) Inventors: Kouji UENO, Kawasaki Kanagawa (JP); Shinichi NAGANO, Yokohama Kanagawa (JP)

(21) Appl. No.: 14/615,929

(22) Filed: Feb. 6, 2015

Related U.S. Application Data
(63) Continuation of application No. PCT/JP2013/071082, filed on Jul. 29, 2013.

(30) Foreign Application Priority Data
Aug. 9, 2012 (JP) 2012-177350

(51) Int. Cl. G06F 17/30

(52) U.S. Cl. CPC G06F 17/30563; G06F 17/30554

(57) ABSTRACT

According to an embodiment, an information processing apparatus includes an obtaining unit; an extracting unit; a first determining unit; and an output unit. The obtaining unit is configured to obtain a specific spot. The extracting unit is configured to extract a first set of partial information from relationship information that indicates geographical relations of inclusion among a plurality of geographical areas. The first set of partial information indicates relations of inclusion among areas that include the specific spot. The first determining unit is configured to determine, as a candidate area group to be output, at least one of the relations of inclusion among areas included in the first set of partial information. The output unit configured to output the candidate area group.

### CROSS-REFERENCE TO RELATED APPLICATION

This application is a continuation of International Application No. PCT/JP2013/071082, filed on Jul. 29, 2013, which claims the benefit of priority from Japanese Patent Application No. 2012-177350, filed on Aug. 9, 2012; the entire contents of which are incorporated herein by reference.

### FIELD

Embodiments described herein relate generally to an information processing apparatus, an information processing terminal, a computer program product, and an information processing method.

### BACKGROUND

There is disclosed a system that searches for geographical information using station names or place names, and provides the geographical information. In such a system, it is possible to expand or reduce the search scope. Besides, there is also disclosed a device that analyzes a specific spot such as a specific location that is input from a user terminal, refers to a result of estimating the scope of interest of the user according to the specific spot, and searches for information that contains the geographical aspect.

However, in the conventional technology, the information that is provided as the search result is about only a single scope corresponding to the specific spot. For that reason, it is not possible to provide information that would enable easy understanding of the geographical relations of inclusion between the specific spot and the other areas.

### BRIEF DESCRIPTION OF THE DRAWINGS

FIG. 1 is a block diagram illustrating an information processing system according to a first embodiment;

FIG. 2 is a schematic diagram illustrating an example of relations of inclusion;

FIG. 3 is a diagram illustrating an exemplary data structure of relationship information;

FIG. 4 is a diagram illustrating an example of the smallest configuration of the relation of inclusion;

FIG. 5 is a schematic diagram illustrating the extraction of a first set of partial information according to the first embodiment;

FIG. 6 is a flowchart for explaining the sequence of operations during the information processing according to the first embodiment;

FIGS. 7 to 13 illustrate examples of display images according to the first embodiment;

FIG. 14 is a schematic diagram illustrating an information processing system according to a second embodiment;

FIG. 15 is a schematic diagram illustrating the extraction of a first set of partial information according to the second embodiment;

FIG. 16 is a schematic diagram illustrating an example of second sets of partial information according to the second embodiment;

FIG. 17 is a schematic diagram illustrating the combining of second sets of partial information according to the second embodiment;

FIG. 18 is a schematic diagram illustrating the extraction of a second set of partial information according to the second embodiment;

FIG. 19 is a flowchart for explaining the sequence of operations performed during the information processing according to the second embodiment;

FIGS. 20 and 21 are schematic diagrams illustrating examples of display images according to the second embodiment;

FIG. 22 is a schematic diagram illustrating an information processing system according to a third embodiment;

FIG. 23 is a flowchart for explaining a sequence of operations during the information processing performed in an information processing terminal according to the third embodiment;

FIG. 24 is a flowchart for explaining the sequence of operations during the information processing performed in a server device according to the third embodiment; and

FIG. 25 is a block diagram illustrating a hardware configuration example of the information processing system, the server device, and the information processing terminal according to the first to third embodiments.

### DETAILED DESCRIPTION

According to an embodiment, an information processing apparatus includes an obtaining unit; an extracting unit; a first determining unit; and an output unit. The obtaining unit is configured to obtain a specific spot. The extracting unit is configured to extract a first set of partial information from relationship information that indicates geographical relations of inclusion among a plurality of geographical areas. The first set of partial information indicates relations of inclusion among areas that include the specific spot. The first determining unit is configured to determine, as a candidate area group to be output, at least one of the relations of inclusion among areas included in the first set of partial information. The output unit configured to output the candidate area group.

Exemplary embodiments of an information processing apparatus, an information processing terminal, a computer program product, and an information processing method according to the invention are described below in detail with reference to the accompanying drawings.

### First Embodiment

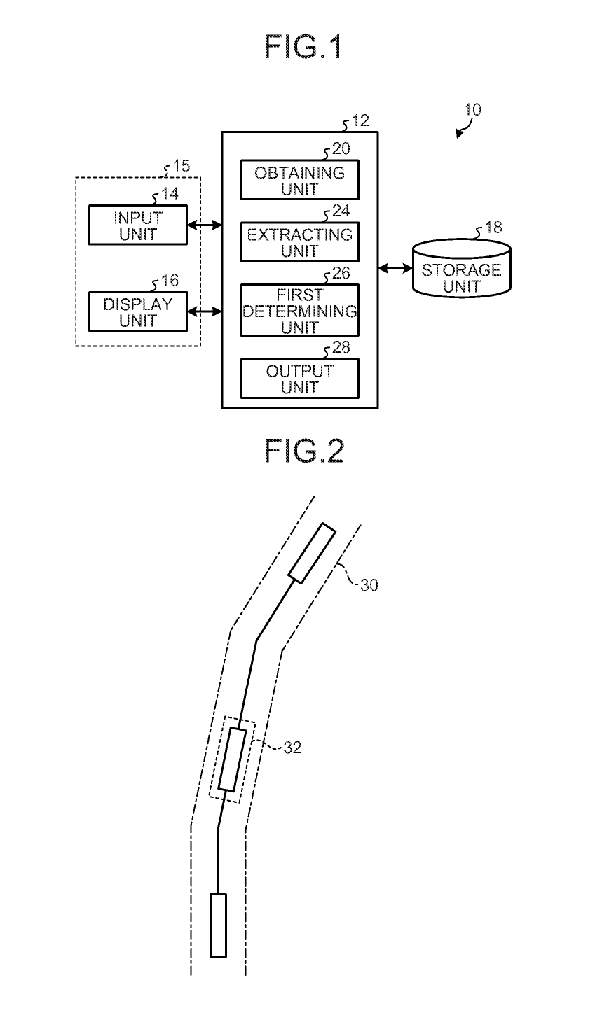

FIG. 1 is a block diagram illustrating a functional configuration of an information processing system 10 according to a first embodiment. The information processing system 10 includes an information processing apparatus 12, an input unit 14, a display unit 16, and a storage unit 18.

In the first embodiment, the explanation is given for a case in which the information processing system 10 includes the information processing apparatus 12, the input unit 14, the display unit 16, and the storage unit 18 as separate constituent elements. However, alternatively, the information processing system 10 can include the information processing apparatus 12 that is configured in an integrated manner with at least one of the information processing apparatus 12, the input unit 14, the display unit 16, and the storage unit 18.

The input unit 14 is a member that receives input of various instructions from the user. The input unit 14 can be configured, for example, by combining one or more of a mouse, buttons, a remote control, a keyboard, a voice recognition device such as a microphone, and an image recognition device.

The display unit 16 is a device for displaying various images. Herein, a known display device such as a liquid crystal display device is used as the display unit 16.

Meanwhile, it is also possible to configure the input unit 14 in an integrated manner with the display unit 16. More particularly, the input unit 14 and the display unit 16 can be configured in an integrated manner as a user interface (UI) unit 15 that is equipped with the input function as well as the display function. The UI unit 15 can be a liquid crystal display (LCD) having a touch-sensitive panel.

The storage unit 18 is used to store relationship information, which is the information indicating the geographical relations of inclusion among a plurality of geographical areas.

Herein, an area points to a geographical area. A plurality of areas defined in the relationship information differs from each other in at least one of the following aspects: the geographical range (i.e., the geographical size); the geographical shape; and the geographical location.

Examples of an area include a shop, a street, a particular location on a street, a street crossing, an electric train line, a station, or a river. However, those are not the only possible examples.

Each area that is defined in the relationship information holds information which contains identification information enabling unique identification of that area, the geographical location of that area, the geographical size of that area, the geographical shape of that area, and the type of that area. Thus, each area is uniquely identifiable by such a variety of information.

The identification information of an area can be the name of that area or can be an identification image of the area. For example, if an area points to a shop, then the name of the shop serves as the name of that area. If an area points to a street, then the name of the street serves as the name of that area. If an area points to an electric train line, then the name of the electric train line serves as the name of that area.

The location of an area points to the geographical location of that area. For example, the location of an area is indicated using the geographical latitude and longitude. Moreover, the location of an area of interest either can be a group of locations corresponding to a plurality of small areas that are obtained by dividing the area of interest, or can be the latitude and longitude of a representative point of the area of interest. For example, the single representative point can be the center location of the area of interest.

The geographical size of an area points to the information that indicates the size of that area. For example, the size can be in the form of the actual measured geographical size of that area or in the form of the relative size ratio with respect to the other areas.

The geographical shape of an area points to the shape of the territory that is geographically covered by that area. Thus, the geographical shape of an area either can be the shape resembling the actual geographical shape or can be a simplified form of the actual geographical shape. As long as the geographical shape of an area is in accordance with the actual geographical shape, there is no restriction on the shape. For example, examples of the geographical shape of an area include the rectangular shape, the polygonal shape, and the circular shape. However, those are not the only possible examples.

The type of an area points to the geographical type of that area. Herein, examples of the geographical type of an area include a city, a street, and a train line. However, those are not the only possible examples.

In the geographical relations of inclusion among a plurality of geographical areas; regarding each area, one or more other areas included in that particular area and one or more other areas in which that particular area is included is represented in a hierarchical way.

FIG. 2 is a schematic diagram illustrating an example of the relations of inclusion.

In FIG. 2, an area 32 represents a station and is included in an area 30, which represents an electric train line on which electric trains run between a plurality of stations also including the station represented by the area 32. Thus, the area 30 representing an electric train line includes the area 32 representing a station on that electric train line. In the first embodiment, the information indicating the relations of inclusion among the areas (in FIG. 2, the area 32 and the area 30) is referred to as relationship information.

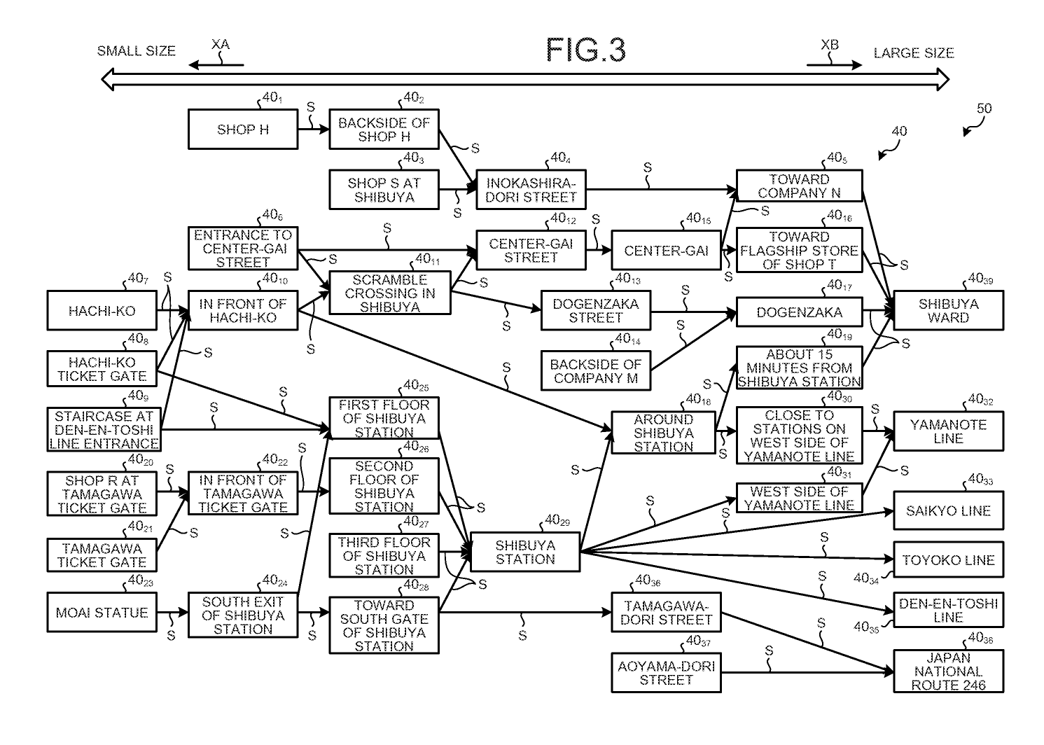

FIG. 3 is a diagram illustrating an exemplary data structure of the relationship information that is stored in the storage unit 18.

Meanwhile, in the first embodiment, the explanation is given for a case when the relationship information is stored in the storage unit 18 in a digraph data structure illustrated by the graph theory in which the areas are considered as nodes and are linked by directed edges having the directions in accordance with the geographical relations of inclusion among the areas. Moreover, in the first embodiment, the explanation is given for a case in which the relationship information has a directed acyclic graph data structure.

Meanwhile, as long as the relationship information indicates the relations of inclusion among the areas, the data structure of the relationship information is not limited to the digraph data structure.

As illustrated in FIG. 3, the data structure of relationship information 50 is such that a plurality of areas 40 (40₁ to 40₃₉) are linked by directed edges S in accordance with the relations of inclusion of each area 40. In FIG. 3, the direction illustrated by an arrow XA indicates the areas 40 having smaller sizes, and the direction illustrated by an arrow XB indicates the areas 40 having larger sizes.

In the first embodiment, the orientation of each directed edge S is such that an area 40 having a smaller size serves as the start point of that directed edge S and an area 40 having a larger size serves as the end point of that directed edge S.

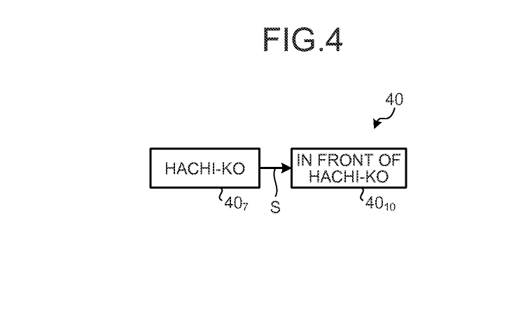

FIG. 4 is a diagram illustrating an example of the smallest configuration of the relation of inclusion. For example, assume that the area 40₇ identified by identification information “Hachi-ko” is geographically included in the area 40₁₀ identified by identification information “in front of Hachi-ko”. In this case, as illustrated in FIG. 4, the relation of inclusion between the area 40₇ and the area 40₁₀ is represented as a data structure in which a directed edge S has the area 40₇ as the start point and has the area 40₁₀ as the end point.

Returning to the explanation with reference to FIG. 3, there are times when a plurality of areas 40 that include a particular area 40 are themselves included in other mutually different areas 40. For that reason, as illustrated in FIG. 3, the relation of inclusion between an area 40 of interest and another area 40, which includes the area 40 of interest and which has the next larger geographical size, is not limited to a one-to-one relation of inclusion. In an identical manner, the relation of inclusion between an area 40 of interest and another area 40, which is included in the area 40 of interest and which has the next smaller geographical size, is not limited to a one-to-one relation of inclusion.

More particularly, in the relationship information 50 illustrated in FIG. 3, the area 40₁₁ identified by identification information “scramble crossing in Shibuya” has a one-to-two relation of inclusion with the area 40₆ identified by identification information “entrance to Center-gai street” and the area 40₁₀ identified by the identification information “in front of Hachi-ko”, which are the areas 40 included in the area 40₁₁ and which have the next smaller geographical sizes. Moreover, in the relationship information 50 illustrated in FIG. 3, the area 40₁₁ identified by the identification information “scramble crossing in Shibuya” has a one-to-two relation of inclusion with the area 40₁₂ identified by identification information “Center-gai street” and the area 40₁₃ identified by identification information “Dogenzaka street”, which are the areas 40 that include the area 40₁₁ and which have the next larger geographical sizes.

Returning to the explanation with reference to FIG. 1, the information processing apparatus 12 is a computer that includes a central processing unit (CPU), a read only memory (ROM), and a random access memory (RAM).

The information processing apparatus 12 is electrically connected to the input unit 14, the display unit 16, and the storage unit 18. Moreover, the information processing apparatus 12 includes an obtaining unit 20, an extracting unit 24, a first determining unit 26, and an output unit 28.

The obtaining unit 20 obtains a specific spot from the input unit 14. Herein, the specific spot points to the geographical location that the user intends to search for. In the first embodiment, the specific spot is a geographical point that is identified by the latitude and longitude. In the first embodiment, the obtaining unit 20 obtains a specific spot from the input unit 14.

The input unit 14 receives input of the specific spot that is input by the user by operating the input unit 14. Then, the input unit 14 sends the specific spot to the obtaining unit 20. Thus, the obtaining unit 20 obtains the specific spot from the input unit 14.

Herein, in order to receive input of the specific spot from the user, a known method can be implemented in the input unit 14. For example, the user inputs the specific spot by indicating a specific location on a map image that is displayed on the UI unit 15.

Alternatively, for example, the user operates the input unit 14 and inputs the address of the specific spot. Then, the input unit 14 sends the address, which is received from the user, to the obtaining unit 20. Subsequently, the obtaining unit 20 makes use of a known technology such as reverse geocoding and obtains the specific spot by converting the address received from the input unit 14 into the latitude and longitude.

Still alternatively, for example, in order to input the current location as the specific spot, an instruction button is displayed on the UI unit 15. When the user operates the input unit 14 (the UI unit 15) and presses the instruction button displayed on the UI unit 15; the input unit 14 sends an instruction signal, which indicates that the current location is the specific spot, to the obtaining unit 20. Upon receiving the instruction signal from the input unit 14, the obtaining unit 20 makes use of the global positioning system (GPS) installed in advance in the information processing apparatus 12, and obtains the current location of the information processing apparatus 12 as the specific spot.

Besides, from the input unit 14, the obtaining unit 20 receives a selected area (described later in detail) or receives a variety of information such as a modification instruction for modifying the areas 40 to be displayed on the display unit 16. Herein, the selected area as well as the variety of information is input by the user by operating the input unit 14, and is then sent from the input unit 14 to the obtaining unit 20.

The extracting unit 24 refers to the relationship information 50 stored in the storage unit 18; and extracts, from the relationship information 50, a first set of partial information that indicates the relations of inclusion among the areas 40 which include the specific spot obtained by the obtaining unit 20.

More specifically, of the relations of inclusion among a plurality of areas 40 defined in the relationship information 50, the extracting unit 24 extracts, as the first set of partial information, the relations of inclusion among the areas 40 which include the specific spot obtained by the obtaining unit 20.

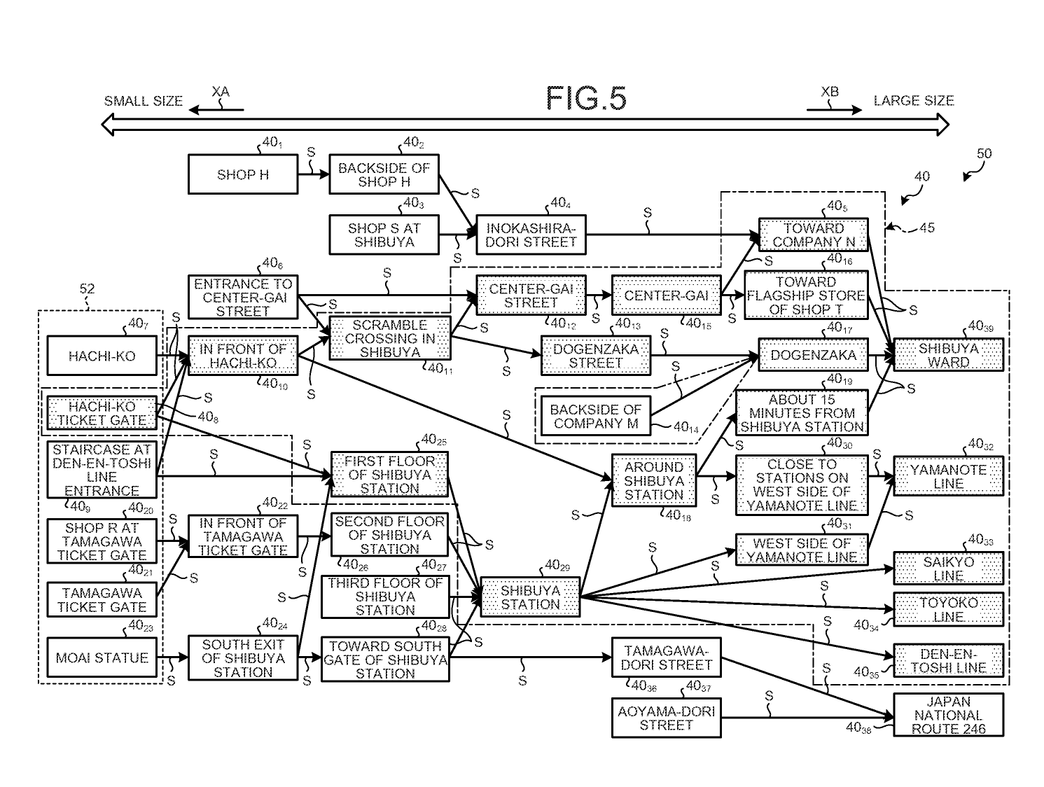

FIG. 5 is a schematic diagram illustrating the extraction of the first set of partial information performed by the extracting unit 24.

For example, as the specific spot, assume that a spot is obtained that is identified by a particular latitude and longitude within the geographical area 40₈ which is identified by identification information “Hachi-ko ticket gate”. In this case, from the relationship information 50, the extracting unit 24 extracts the first set of partial information that indicates the relations of inclusion among the areas 40 including the specific spot which has been obtained.

More specifically, the extracting unit 24 refers to the location of each area 40 defined in the relationship information 50 and determines whether or not that area 40 includes the specific spot. Then, from the relationship information, the extracting unit 24 extracts the relations of inclusion among the areas 40 which include the specific spot.

Meanwhile, the extracting unit 24 can extract the first set of partial information from the relationship information 50 by implementing the following method.

For example, from among the areas 40 defined in the relationship information 50, the extracting unit 24 identifies such areas 40 which do not include any other area 40. In this case, from among a plurality of areas 40 defined in the relationship information 50 in FIG. 5; the extracting unit 24 identifies the areas 40₇, 40₈, 40₉, 40₂₀, 40₂₁, and 40₂₃ illustrated within a line drawing 52. Subsequently, from among those areas 40 (i.e., from among the areas 40₇, 40₈, 40₉, 40₂₀, 40₂₁, and 40₂₃), the extracting unit 24 identifies the area 40 that includes the specific spot (for example, identifies the area 40₈ which is identified by the identification information “Hachi-ko ticket gate”).

Moreover, the extracting unit 24 extracts the first set of partial information from the relationship information 50 by extracting, from the relationship information 50, the relations of inclusion between the area 40₈ which is identified by the identification information “Hachi-ko ticket gate” and all other areas 40 that include the area 40₈.

In this case, from the relationship information 50, the extracting unit 24 extracts the relations of inclusion between the area 40₈ which is identified by the identification information “Hachi-ko ticket gate” and all other areas 40 that include the area 40₈ (i.e., the areas 40₁₀, 40₁₁, 40₂₅, 40₁₂, 40₁₃, 40₂₉, 40₁₈, 40₁₅, 40₅, 40₁₆, 40₁₇, 40₁₉, 40₃₀, 40₃₁, 40₃₉, 40₃₂, 40₃₃, 40₃₄, and 40₃₅) as the first set of partial information (see a line drawing 45 illustrated in FIG. 5).

The first determining unit 26 determines, as a candidate area group, at least one of the relations of inclusion among the areas 40 that are included in the first set of partial information extracted by the extracting unit 24. Then, the output unit 28 outputs the candidate area group, which is determined by the first determining unit 26, on the display unit 16. As a result, the candidate area group gets displayed on the display unit 16.

The candidate area group is the information indicating the relations of inclusion among the areas to be output from the first set of partial information that is extracted by the extracting unit 24. In the first embodiment, an area to be output points to an area that is to be displayed on the UI unit 15. Thus, in the following explanation, the term “output” has the same meaning as the term “display”.

As long as the candidate area group is the information indicating the relations of inclusion among at least some areas from among the relations of inclusion among a plurality of areas that are included in the first set of partial information, it serves the purpose. Hence, the candidate area group can also point to the entire first set of partial information.

In the first embodiment, from among a plurality of areas 40 that are included in the first set of partial information extracted by the extracting unit 24, the first determining unit 26 firstly specifies a single area 40 as the specific area.

Herein, the first determining unit 26 either can specify an arbitrary single area 40, which is included in the first set of partial information, as the specific area; or can specify the specific area according to a predetermined specification rule. Alternatively, the first determining unit 26 can obtain the specific area from the input unit 14 via the obtaining unit 20.

As the predetermined specification rule, it is possible to set a rule according to which, for example, from among a plurality of areas 40 included in the first set of partial information; the area 40 having the largest size is specified as the specific area, or the area 40 having the smallest size is specified as the specific area, or the area 40 closest to the average size of the sizes of all areas 40 is specified as the specific area. However, those are not the only possible examples of the predetermined specification rule.

If the first determining unit 26 obtains the specific area from the input unit 14 via the obtaining unit 20, the following operations are performed in the information processing apparatus 12.

For example, the output unit 28 of the information processing apparatus 12 displays the first set of partial information, which is extracted by the extracting unit 24, on the display unit 16. For example, on the display unit 16 is displayed the first set of partial information that indicates the relations of inclusion of a plurality of area 40 illustrated within the line drawing 45 in FIG. 5. Then, on the display unit 16, the output unit 28 further displays instruction information that prompts selection of a single area 40.

When the user operates the input unit 14 and selects a single area 40 from the first set of partial information, the input unit 14 receives the selected area 40 as the specific area and sends it to the obtaining unit 20. Then, the obtaining unit 20 specifies the specific area, which is received from the input unit 14, as the specific area indicating a single area 40 from among a plurality of areas 40 included in the first set of partial information.

Subsequently, as the candidate area group, the first determining unit 26 determines the relations of inclusion between at least the specific area, the area 40 having the next smaller size to the size of the specific area from among the areas 40 geographically included in the specific area, and the area 40 having the next larger size to the size of the specific area from among the areas 40 that geographically include the specific area.

However, there is no restriction on the first determining unit 26 to determine, as the candidate area group, the relations of inclusion between the specific area and the areas 40 present at the adjacent level of the specific area in the vertical direction of the hierarchy of sizes. Herein, the vertical direction indicates the direction in which the sizes increase and the direction in which the sizes decrease.

Alternatively, for example, as the candidate area group, the first determining unit 26 can determine the relations of inclusion between the specific area and the areas 40 present up to a predetermined level (for example, up to the second level) from the specific area in the vertical direction of the hierarchy of sizes.

Then, as described above, on the display unit 16, the output unit 28 displays the candidate area group that is determined by the first determining unit 26.

Subsequently, the input unit 14 further receives input of a single area 40, which is selected by the user from the candidate area group displayed on the display unit 16, as the selected area. That is, the user operates the input unit 14 and selects a single area 40 from the candidate area group that is displayed on the display unit 16. Then, the obtaining unit 20 receives the selected area from the input unit 14; and the first determining unit 26 specifies the selected area as the new specific area and determines, as the new candidate area group, at least some relations of inclusion including the specific area from the first set of partial information extracted by the extracting unit 24.

Once the new candidate area group is determined by the first determining unit 26, the output unit 28 performs control to output that candidate area group on the display unit 16.

More particularly, the output unit 28 performs control to create a display image that illustrates the relations of inclusion among the areas 40 that are defined in the candidate area group, and then to display the display image on the display unit 16.

For example, the output unit 28 creates a display image in which, for a plurality of areas 40 defined in the candidate area group, an image indicating at least one item from among the names of the areas 40, the locations of the areas 40, the geographical sizes of the areas 40, the geographical shapes of the areas 40, and the types of the areas 40 is illustrated in the display form representing the relations of inclusion among those areas 40.

Given below is the explanation of a sequence of operations performed in the information processing apparatus 12.

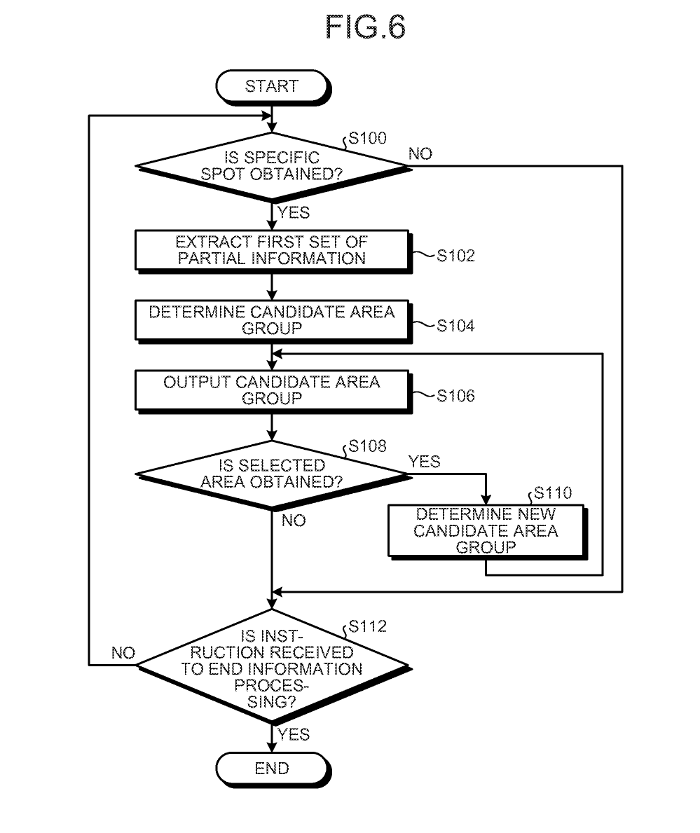

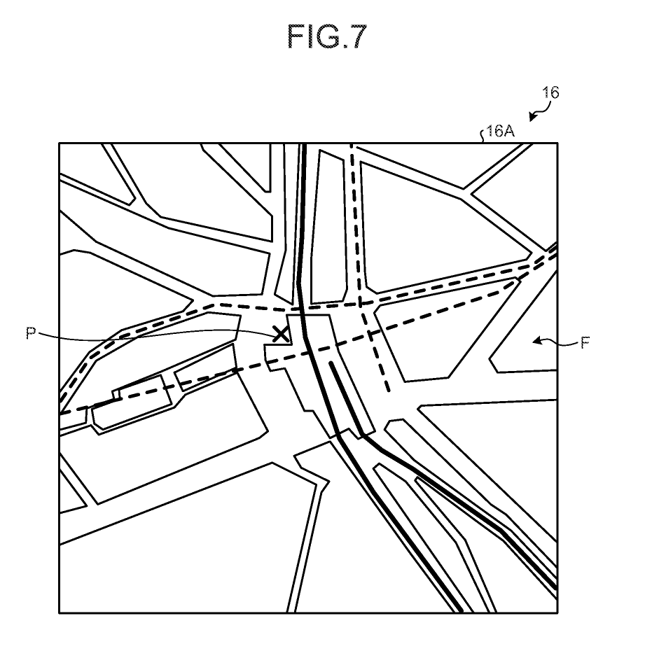

FIG. 6 is a flowchart for explaining the sequence of operations performed in the information processing apparatus 12 according to the first embodiment.

Firstly, the obtaining unit 20 determines whether or not a specific spot is received from the input unit 14 (Step S100). If it is determined that a specific spot is received from the input unit 14 (Yes at Step S100), then the system control proceeds to Step S102.

Subsequently, from the relationship information 50, the extracting unit 24 extracts a first set of partial information that indicates the relations of inclusion among the areas 40 which include the specific spot obtained by the obtaining unit 20 (Step S102).

Then, the first determining unit 26 determines, as a candidate area group, the relations of inclusion among at least some of the areas 40 that are included in the first set of partial information extracted at Step S102 (Step S104). Subsequently, on the display unit 16, the output unit 28 outputs the candidate area group that is determined by the first determining unit 26 either at Step S104 or at Step S110 (described later) (Step S106). As a result, the candidate area group gets displayed on the display unit 16.

Subsequently, the obtaining unit 20 determines whether or not a selected area is obtained from the input unit 14 (Step S108). If it is determined that a selected area is obtained from the input unit 14 (Yes at Step S108), then the system control proceeds to Step S110.

Then, the first determining unit 26 specifies the selected area, which is obtained at Step S108, as the new specific area; and, from the first set of partial information extracted at Step S104, determines a new candidate area group that includes the new specific area (Step S110). The system control then returns to Step S106.

Meanwhile, if it is determined that no specific spot is received from the input unit 14 (No at Step S100), then the system control proceeds to Step S112. Moreover, if it is determined that no selected area is obtained from the input unit 14 (No at Step S108), then the system control proceeds to Step S112.

Subsequently, the obtaining unit 20 determines whether or not to end the information processing (Step S112). Herein, the obtaining unit 20 performs the determination at Step S112 by determining whether or not information indicating the end of information processing is obtained from the input unit 14. In this case, if the user operates the input unit 14 and inputs the information indicating the end of information processing, then the input unit 14 can send the information indicating the end of information processing to the obtaining unit 20. Subsequently, by determining whether or not the information indicating the end of information processing is obtained from the input unit 14, the obtaining unit 20 can perform the determination at Step S112. Alternatively, the obtaining unit 20 can perform the determination at Step S112 by determining whether or not a signal indicating termination of power supply to the information processing apparatus 12 is received as a result of an operation of a power switch (not illustrated) of the information processing apparatus 12.

If it is determined not to end the information processing (No at Step S112), then the system control returns to Step S100. On the other hand, if it is determined to end the information processing (Yes at Step S112); then that marks the end of the present routine.

As a result of the abovementioned information processing in the information processing apparatus 12; a candidate area group, which represents the relations of inclusion regarding the user-specified specific spot, gets displayed on the display unit 16 (or on the UI unit 15).

FIGS. 7 to 11 illustrate examples of display images that are displayed on the display unit 16 as a result of the information processing performed in the information processing apparatus 12 according to the first embodiment. Each of those display images is created by the output unit 28.

FIG. 7 is a schematic diagram illustrating an exemplary display image 16A that is displayed on the display unit 16 in response to the user input of a specific spot P.

For example, as illustrated in FIG. 7, the output unit 28 performs control display the display image 16A, which includes a map image F, on the display unit 16. Then, the user operates the input unit 14 and inputs a specific location in the map image F that is displayed on the display unit 16 (the UI unit 15). With that, the specific spot P is received from the user. Then, the obtaining unit 20 obtains the specific spot P from the input unit 14.

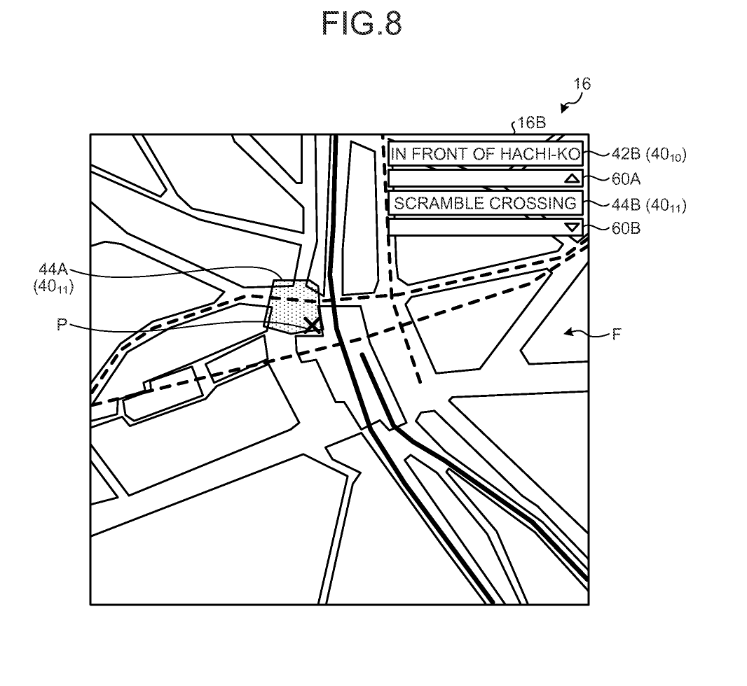

FIG. 8 is a schematic diagram illustrating a display image 16B of the candidate area group and illustrating a condition in which a single area 40 is selected as the selected area.

Herein, assume that the specific spot P is present in the area 40₈ which is identified by the identification information “Hachi-ko ticket gate”. In this case, as the first set of partial information indicating the relations of inclusion among the areas 40 which include the specific spot P, the extracting unit 24 extracts the relations of inclusion between the area 40₈ which is identified by the identification information “Hachi-ko ticket gate” and all other areas 40 that include the area 40₈ (i.e., the areas 40₁₀, 40₁₁, 40₂₅, 40₁₂, 40₁₃, 40₂₉, 40₁₈, 40₁₅, 40₅, 40₁₆, 40₁₇, 40₁₉, 40₃₀, 40₃₁, 40₃₉, 40₃₂, 40₃₃, 40₃₄, and 40₃₅) (see the line drawing 45 illustrated in FIG. 5).

Moreover, assume that the first determining unit 26 further specifies the area 40₁₁, which is identified by the identification information “scramble crossing in Shibuya”, as the specific area. Furthermore, assume that, as the candidate area group, the first determining unit 26 determines the area 40₁₀ identified by the identification information “in front of Hachi-ko”, the area 40₆ identified by identification information “entrance to Center-gai street”, the area 40₁₂ identified by identification information “Center-gai street”, and the area 40₁₃ identified by identification information “Dogenzaka street”, which are the areas 40 having relations of inclusion with the area 40₁₁ and which at least have the geographical sizes adjacent to the area 40₁₁.

In this case, the output unit 28 performs control to display the display image 16B of the candidate area group on the display unit 16. As illustrated in FIG. 8, in the display image 16B is illustrated the relations of inclusion of at least some areas 40 from among the areas 40 defined in the candidate area group.

In the first embodiment, the display image 16B contains an image of geographical shapes (sometimes referred to as a geographical shape image) in which each area 40 defined in the candidate area group is illustrated at the location corresponding to the location of that area 40 in the map image F and is illustrated having the geographical shape of a size dependent on the size of that area 40. In addition, in the display image 16B are illustrated the names of the areas 40, an instruction button (a selection button 60A) for issuing an instruction to display the areas having larger sizes, and an instruction button (a selection button 60B) for issuing an instruction to display the areas having smaller sizes. Besides, in the display image 16B is also illustrated the display of the previously-selected area (in FIG. 8, see a display position 42B of the area 40₁₀ that is identified by the identification information “in front of Hachi-ko”).

Then, for example, the user operates the input unit 14 and selects the area 40₁₁, which is identified by the identification information “scramble crossing in Shibuya”, as the selected area from among a plurality of areas 40 defined in the candidate area group. For example, the user operates the input unit 14 and selects a display position 44B that indicates the name of the area 40₁₁. As a result, the area 40₁₁ gets selected as the selected area.

As a result, on the display unit 16, a geographical shape image 44A of the area 40₁₁ is displayed in an overlapping manner on the specific spot P; and the display position 44B indicating the name “scramble crossing” of the area 40₁₁ is displayed in a highlighted manner.

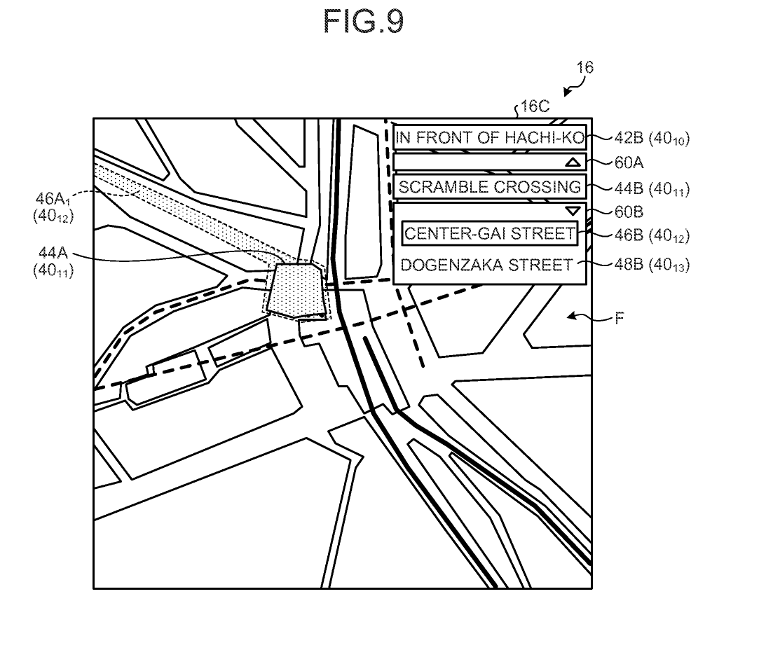

On the other hand, if the user operates the input unit 14 and selects the selection button 60B, an instruction is issued to display the areas 40 that include the area 40₁₁ identified by the identification information “scramble crossing in Shibuya” and that have the next larger sizes to the size of the area 40₁₁. As a result, on the display unit 16, the output unit 28 displays a display image 16C illustrated in FIG. 9.

FIG. 9 is a schematic diagram illustrating a condition in which the name of the area 40₁₂ identified by the identification information “Center-gai street” (see a display position 46B) and the name of the area 40₁₃ identified by the identification information “Dogenzaka street” (see a display position 48B), which are the areas 40 that include the area 40₁₁ identified by the identification information “scramble crossing in Shibuya” and which have the next larger geographical sizes to the size of the area 40₁₁, are further displayed. Moreover, in FIG. 9 is illustrated the condition in which the area 40₁₂ identified by the identification information “Center-gai street” is temporarily selected by an operation of the input unit 14.

As illustrated in FIG. 9, the output unit 28 displays the display image 16C in which a geographical shape image 46A₁ of the area 40₁₂, which is identified by the identification information “Center-gai street” and which is selected on a temporary basis, is displayed in an overlapping manner on the geographical shape image 44A of the area 40₁₁, which is identified by the identification information “scramble crossing in Shibuya”. Moreover, in the display image 16C, the output unit 28 displays, in a highlighted manner, the display position 46B at which the name of the temporarily-selected area 40 is illustrated.

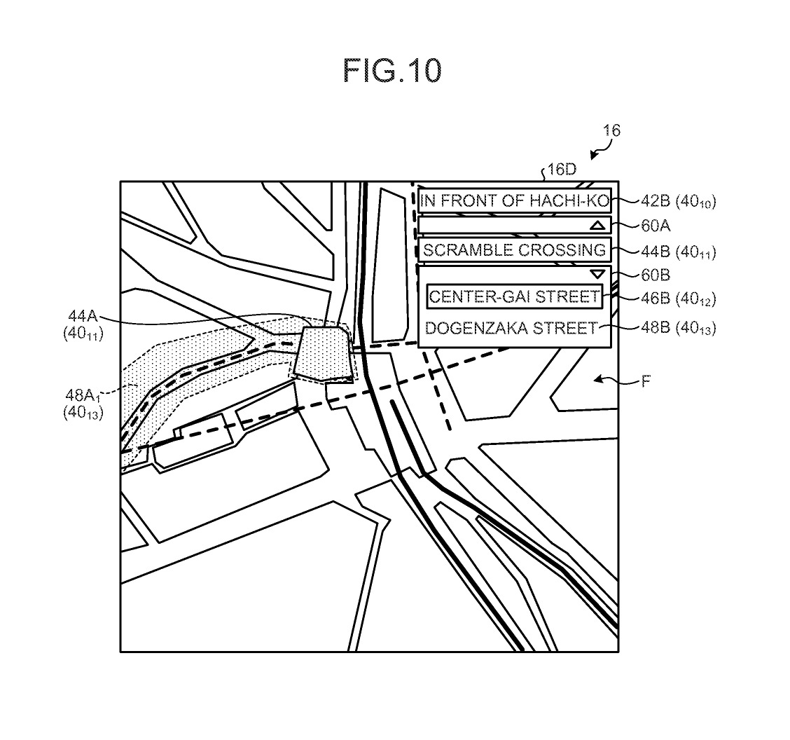

In contrast, if the user operates the input unit 14 and temporarily selects the area 40₁₃ that is identified by the identification information “Dogenzaka street”; then, as illustrated in FIG. 10, the output unit 28 displays a display image 16D in which a geographical shape image 48A₁ of the area 40₁₃, which is identified by the identification information “Dogenzaka street” and which is selected on a temporary basis, is displayed in an overlapping manner on the already-selected geographical shape image 44A of the area 40₁₁, which is identified by the identification information “scramble crossing in Shibuya”. Moreover, the output unit 28 displays, in a highlighted manner, the display position 48B at which the name of the temporarily-selected area 40 is illustrated.

As a result, the user becomes able to effectively recognize the effect of a change in the selected area.

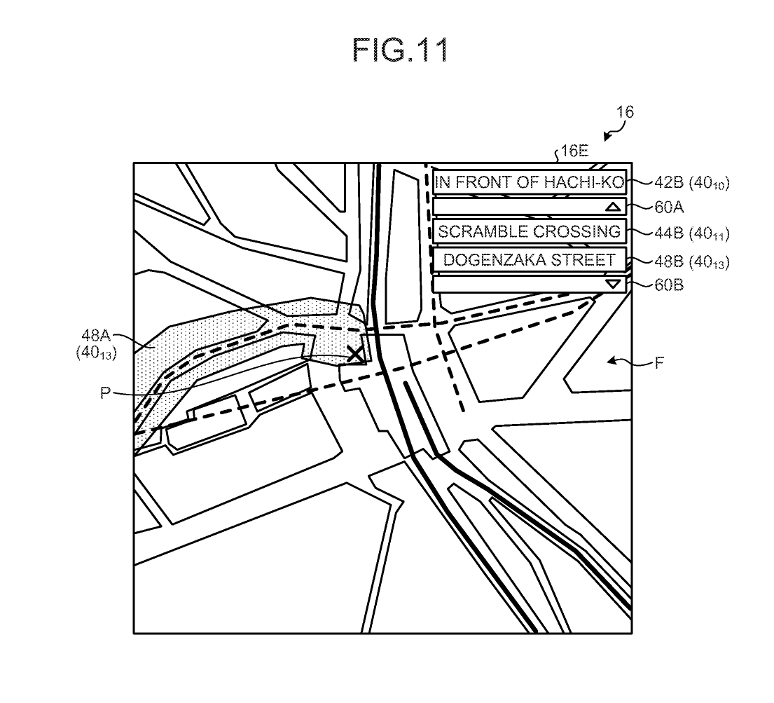

FIG. 11 illustrates a display image 16E of a condition in which the user operates the input unit 14 and selects the temporarily-selected area 40₁₃, which is identified by the identification information “Dogenzaka street”, as the selected area.

As illustrated in FIG. 11, the output unit 28 displays the geographical shape image 48A of the selected area 40₁₃, which is identified by the identification information “Dogenzaka street”, in a more highlighted manner as compared to the temporarily-selected condition (FIG. 10). Moreover, the output unit 28 displays the display position 48B, at which the name of the selected area 40 is illustrated, in a more highlighted manner as compared to the temporarily-selected condition (FIG. 10).

In the condition in which a single area 40 of a plurality of areas 40 displayed on the display unit 16 is selected on a temporary basis; if the user operates the input unit 14 and again selects the temporarily-selected area 40, then that area is assumed to be selected as the selected area. In this case, information indicating the selection of that area as the selected area is sent to the obtaining unit 20 via the input unit 14.

Thus, the obtaining unit 20 obtains the selected area (herein, the area 40₁₃ that is identified by the identification information “Dogenzaka street”) that is received as input by the input unit 14. Then, as described above, the first determining unit 26 sets the selected area as the specific area and determines a new candidate area group that includes the specific area. Subsequently, the output unit 28 performs control to create the display image 16E that illustrates the newly-determined candidate area group, and to display the display image 16E on the display unit 16.

For that reason, in the information processing apparatus 12, it becomes possible to provide information that enables easy understanding of the geographical relations of inclusion of the specific spot P.

Moreover, in the information processing apparatus 12, from among a plurality of areas 40, the relations of inclusion between the area 40 selected by the user and the other areas 40 can be provided in an interactive manner.

Meanwhile, the output unit 28 can also display the geographical shape of each area 40 in the form of a sketch drawing on the display unit 16.

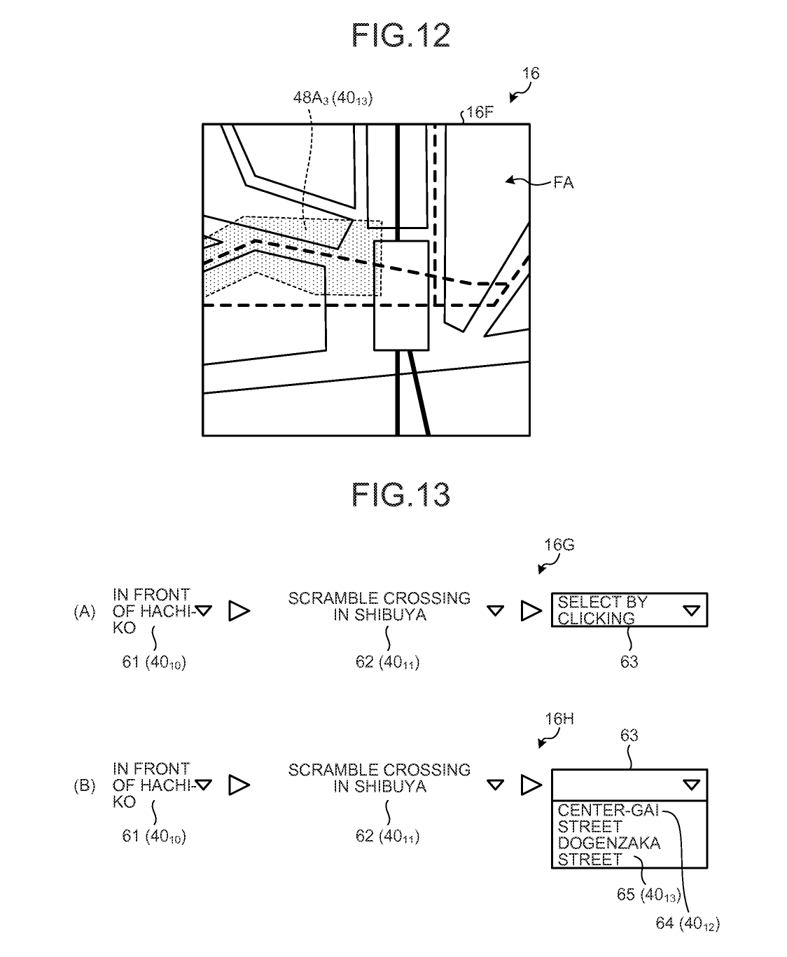

FIG. 12 is a schematic diagram illustrating another example of a display image.

As illustrated in FIG. 12, on the display unit 16, the output unit 28 can display a display image 16F in which the geographical shape of each area 40 defined in the candidate area group is illustrated in a simplified form.

The display image 16F illustrated in FIG. 12 is a schematic diagram in which the temporarily-set area 40₁₃, which identified by the identification information “Dogenzaka street”, is displayed as a sketch drawing 48A₃ on a simplified map image FA.

In this way, by displaying a sketch drawing of each area 40, the candidate area group can be displayed in an effective manner even in the case when detailed shape information is not required and the provision of only a broad pattern serves the purpose or in the case when the display image is to be displayed on a relatively smaller display screen such as the display screen of a handheld device.

Meanwhile, as long as such a display image is displayed on the display unit 16 in which the relations of inclusion among a plurality of areas 40 defined in the candidate area group are illustrated in a viewable manner, the output unit 28 need not display the display image in which the geographical shape image of each area 40 is displayed on the map image F or on the map image FA as illustrated in FIGS. 7 to 12.

For example, the output unit 28 can display the names of the areas 40 in a display form that illustrates the relations of inclusion among the areas 40 defined in the candidate area group.

FIG. 13 is a schematic diagram illustrating an example of a display screen on which the names of the areas 40 are displayed in a display form that illustrates the relations of inclusion among the areas 40 defined in the candidate area group.

As illustrated in (A) in FIG. 13, in a display image 16G, the display form is such that, from among a plurality of areas 40 defined in the candidate area group, the area 40₁₁ that is identified by the identification information “scramble crossing in Shibuya” has a name 62 thereof displayed in the center; and a selection button 63, which is used for selecting the area 40 that includes the area 40₁₁ and that has the next larger size to the size of the area 40₁₁, is displayed on the right-hand side of the name 62. Moreover, on the left-hand side of the name 62 is displayed a name 61 of the area 40₁₀ that is identified by the identification information “in front of Hachi-ko”, that is included in the area 40₁₁ having the name 62, and that has the next smaller size to the size of the area 40₁₁.

If the selection button 63 is selected as a result of a user operation of the input unit 14; then, in a display image 16H illustrated in (B) in FIG. 13, a name 64 of the area 40₁₂ identified by the identification information “Center-gai street” and a name 65 of the area 40₁₃ identified by the identification information “Dogenzaka street”, which are the areas 40 that include the area 40₁₁ and which have the next larger geographical sizes to the size of the area 40₁₁, are displayed adjacent to each other in the vertical direction.

Such a display form can also be adopted.

As described above, in the information processing apparatus 12 according to the first embodiment, from the relationship information 50 that indicates the relations of inclusion among a plurality of geographical areas 40, the extracting unit 24 extracts the first set of partial information that indicates the relations of inclusion among the areas which include the specific spot P obtained by the obtaining unit 20. Then, as the candidate area group to be output, the first determining unit 26 determines at least some of the areas 40 that are included in the first set of partial information. Subsequently, the output unit 28 outputs the candidate area group.

For that reason, in the information processing apparatus 12 according to the first embodiment, it becomes possible to output information that indicates the relations of inclusion among a plurality of areas 40 which include a specific spot that has been obtained.

Consequently, in the information processing apparatus 12 according to the first embodiment, it becomes possible to provide information that enables easy understanding of the geographical relations of inclusion of the specific spot.

Moreover, in the information processing apparatus 12 according to the first embodiment, when a single area 40 is selected from among the areas 40 defined in the candidate area group that is displayed on the display unit 16 (the UI unit 15), a new candidate area group indicating the relations of inclusion between the selected area 40 and the other areas 40 is determined from the first set of partial information and is displayed on the display unit 16 (the UI unit 15).

For that reason, in the information processing apparatus 12, from among a plurality of areas 40, the relations of inclusion between the area 40 selected by the user and the other areas 40 can be provided in an interactive manner.

### Second Embodiment

In a second embodiment, the first set of partial information is disaggregated into a plurality of second sets of partial information, and the relations of inclusion among at least some of the areas 40 included in the second sets of partial information are determined as the candidate area group.

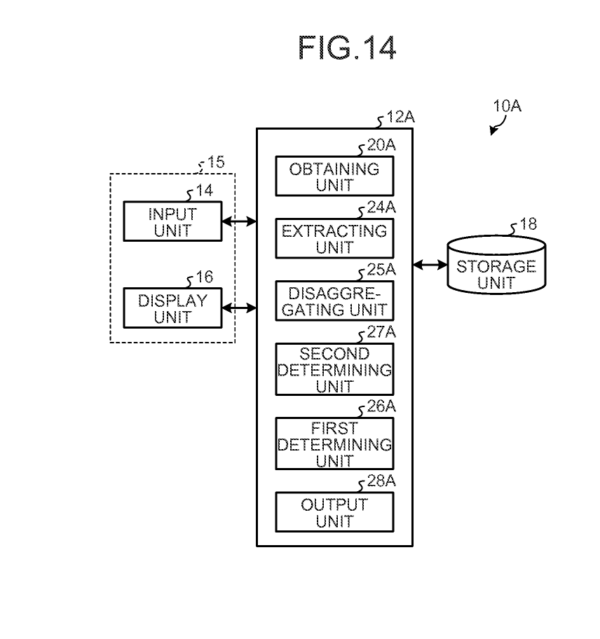

FIG. 14 is a schematic diagram illustrating an information processing system 10A according to the second embodiment.

As illustrated in FIG. 14, the information processing system 10A includes an information processing apparatus 12A, the input unit 14, the display unit 16, and the storage unit 18. Herein, the input unit 14, the display unit 16, and the storage unit 18 are identical to those described in the first embodiment.

The information processing apparatus 12A is a computer that includes a CPU, a ROM, and a RAM.

Moreover, the information processing apparatus 12A includes an obtaining unit 20A, an extracting unit 24A, a disaggregating unit 25A, a second determining unit 27A, a first determining unit 26A, and an output unit 28A.

The obtaining unit 20A obtains a specific spot from the input unit 14. Moreover, the obtaining unit 20A obtains the range of sizes of the target areas 40 for display from the input unit 14. More particularly, as the range of sizes, the obtaining unit 20A obtains the smallest size and the largest size among the target areas 40 for display from the input unit 14.

For example, on the display unit 16, the output unit 28A displays an input screen for inputting the largest size and the smallest size of the areas 40. Then, the user operates the input unit 14 and inputs the largest size and the smallest size among the target areas 40 for display. As a result, the input unit 14 receives input of the largest size and the smallest size, and sends the received information to the obtaining unit 20A.

For example, the user can perform the input via the input unit 14 by inputting predetermined numerical values as the smallest size and the largest size or by inputting numerical values with the use of a graphical user interface (GUI) component such as a slider that is displayed on the display unit 16.

Besides, a map image is displayed on the display unit 16 and an instruction for enlarging or reducing the map represented by that map image is received from the user via the input unit 14. Then, according to the instruction, the obtaining unit 20A can determine the largest possible size of the areas 40 displayed on the display unit 16, and multiply a predetermined constant number to the largest possible size so as to obtain the largest size and the smallest size.

The extracting unit 24A refers to the relationship information 50 stored in the storage unit 18; and extracts, as a first set of partial information, the relations of inclusion among the areas 40 that include the specific spot obtained by the obtaining unit 20 and that are within the range of sizes from the smallest size to the largest size.

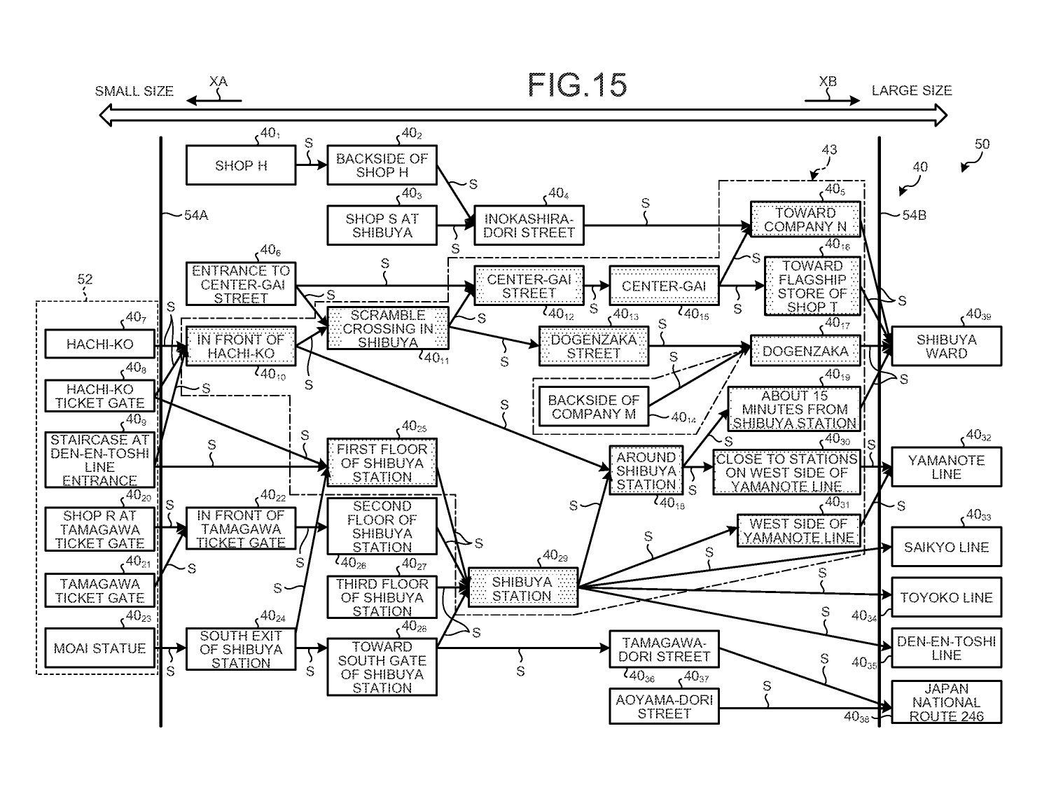

FIG. 15 is a schematic diagram illustrating the extraction of the first set of partial information performed by the extracting unit 24A.

For example, as the specific spot, assume that a spot is obtained that is identified by a particular latitude and longitude within the geographical area 40₈ which is identified by the identification information “Hachi-ko ticket gate”. In this case, in an identical manner to the extracting unit 24 according to the first embodiment, the extracting unit 24A extracts, from the relationship information 50, the relations of inclusion among the areas 40 which include the specific spot that has been obtained. In addition, as the first set of partial information, the extracting unit 24A extracts the relations of inclusion among the areas 40 within the range of sizes from the smallest size to the largest size as obtained by the obtaining unit 20A (i.e., with reference to FIG. 15, the extracting unit 24A extracts the relations of inclusion among the areas 40 present between line drawings 54A and 54B).

For that reason, in the second embodiment, from the relationship information 50, the extracting unit 24A extracts the relations of inclusion among, for example, the areas 40₁₀, 40₁₁, 40₂₅, 40₁₂, 40₁₃, 40₂₉, 40₁₈, 40₁₅, 40₅, 40₁₆, 40₁₇, 40₁₉, 40₃₀, and 40₃₁ illustrated in FIG. 15, which are the areas 40 that include the specific spot from among a plurality of areas 40 defined in the relationship information 50, as the first set of partial information.

The disaggregating unit 25A disaggregates the first set of partial information, which is extracted by the extracting unit 24A, into a plurality of second sets of partial information each of which indicates a one-to-one relation of inclusion between the areas 40 having adjoining sizes.

Meanwhile, as described above, the relation of inclusion between the areas 40 having adjoining sizes in the relationship information 50 is not limited to a one-to-one relation of inclusion.

More particularly, in the relationship information illustrated in FIG. 15, the area 40₁₁, which is identified by the identification information “scramble crossing in Shibuya”, has a one-to-two relation of inclusion with the area 40₆ identified by the identification information “entrance to Center-gai street” and the area 40₁₀ identified by the identification information “in front of Hachi-ko”, which are the areas 40 included in the area 40₁₁ and which have the next smaller geographical sizes. Moreover, in the relationship information 50 illustrated in FIG. 15, the area 40₁₁, which is identified by the identification information “scramble crossing in Shibuya”, has a one-to-two relation of inclusion with the area 40₁₂ identified by identification information “Center-gai street” and the area 40₁₃ identified by identification information “Dogenzaka street”, which are the areas 40 that include the area 40₁₁ and which have the next larger geographical sizes.

In the case when the relation of inclusion between the areas 40 having adjoining sizes is either a one-to-many relation of inclusion or a many-to-one relation of inclusion, the disaggregating unit 25A disaggregates the first set of partial information into a plurality of second sets of partial information in each of which the relation of inclusion between the areas 40 having adjoining sizes is a one-to-one relation of inclusion.

For example, the disaggregating unit 25A identifies such areas 40 in the first set of partial information, which is extracted by the extracting unit 24A, that do not include any other area 40 (sometimes referred to as the areas 40 that do not have any child node). Moreover, the disaggregating unit 25A identifies such areas 40 in the first set of partial information that are not included in any other area 40 (sometimes referred to as the areas 40 that do not have any parent node).

Then, from each of those areas 40 in the first set of partial information which do not include any other area 40, the disaggregating unit 25A sequentially identifies, in the direction toward the geographically larger areas 40, such areas 40 for which the relations of inclusion with the areas 40 are one-to-one relations of inclusion. With that, from the areas 40 in the first set of partial information that do not include any other area 40 toward the areas 40 in the first set of partial information that are not included in any other area 40, the disaggregating unit 25A extracts a group of areas 40 that are linked by unbranched directed edges S as a second set of partial information. The disaggregating unit 25A repeats this operation with respect to all areas 40 and the directed edges S included in the first set of partial information, and disaggregates the first set of partial information into a plurality of second sets of partial information.

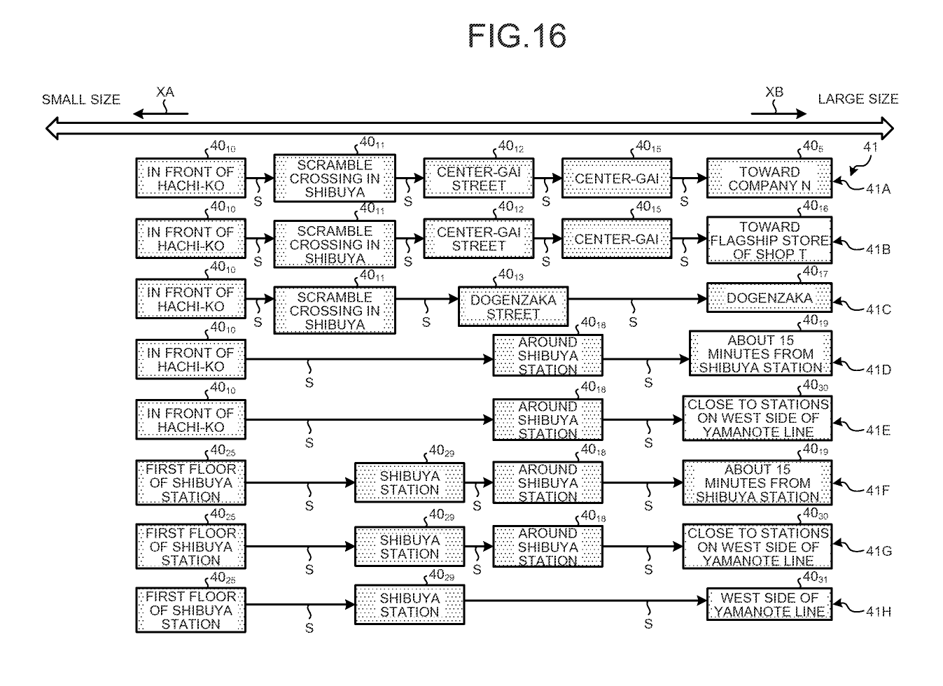

FIG. 16 is a schematic diagram illustrating an example of the second sets of partial information.

For example, the disaggregating unit 25A disaggregates the first set of partial information illustrated in FIG. 15 (see the areas 40 within a line drawing 43 and see the directed edges S in FIG. 15) into a plurality of second sets of partial information. As a result, eight second sets of partial information, namely, a second set of partial information 41A to a second set of partial information 41H are obtained as illustrated in FIG. 16.

Each second set of partial information 41 (i.e., the second set of partial information 41A to the second set of partial information 41H) holds a relation of inclusion and indicates one-to-one relations of inclusion between the areas 40 having adjoining sizes. For that reason, each of a plurality of areas 40 included in each second set of partial information has a one-to-one relation of inclusion starting from the area 40 having the smallest size toward the area 40 having the largest size. For that reason, by displaying the second sets of partial information 41 on the UI unit 15 or on the display unit 16; the relations of inclusion among the areas 40 can be provided in a continuous and easy-to-understand manner according to the sizes along the directed edges S that link the areas 40.

Meanwhile, the disaggregating unit 25A can combine some of the second sets of partial information 41, which are obtained by disaggregating the first set of partial information, and create a new second set of partial information 41.

In this case, for example, the disaggregating unit 25A treats each area 40 as a sign and treats each second set of partial information as a sign list. Then, the disaggregating unit 25A obtains the distances between the second sets of partial information 41 as Levenshtein distances, and combines the second sets of partial information 41 that are close to each other. Such combining can be performed easily if done, for example, in the order of sizes of the areas 40.

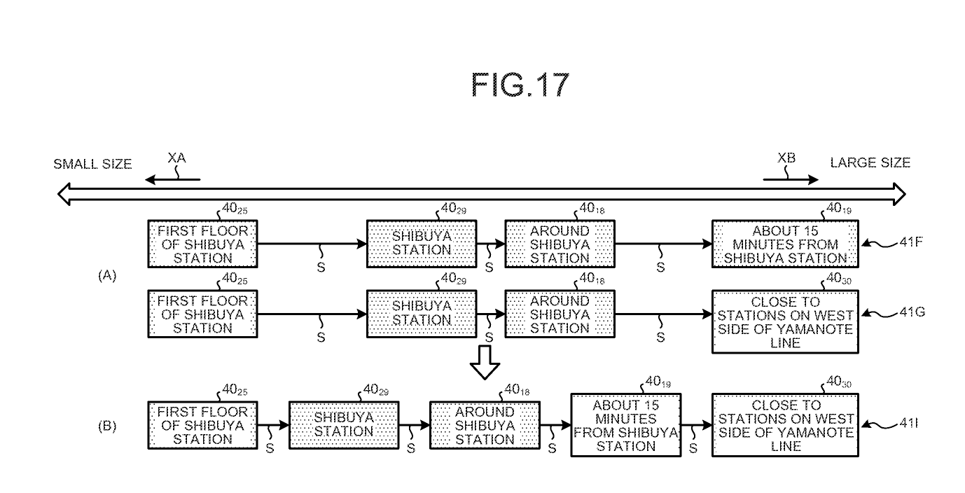

FIG. 17 is a schematic diagram illustrating the combining of the second sets of partial information 41 performed by the disaggregating unit 25A.

For example, as illustrated in (A) in FIG. 17, the disaggregating unit 25A combines the second set of partial information 41F with the second set of partial information 41G. Herein, the second set of partial information 41F indicates the relations of inclusion in which the area 40₂₅ identified by identification information “first floor of Shibuya station”, the area 40₂₉ identified by identification information “Shibuya station”, the area 40₁₈ identified by identification information “around Shibuya station”, and the area 40₁₉ identified by identification information “about 15 minutes from Shibuya station” are included in that particular order. The second set of partial information 41G indicates the relations of inclusion in which the area 40₂₅ identified by the identification information “first floor of Shibuya station”, the area 40₂₉ identified by the identification information “Shibuya station”, the area 40₁₈ identified by the identification information “around Shibuya station”, and the area 40₃₀ identified by identification information “close to stations on west side of Yamanote line” are included in that particular order.

Thus, the disaggregating unit 25A combines the second set of partial information 41F with the second set of partial information 41G; and, as illustrated in (B) in FIG. 17, creates a new second set of partial information 411 that indicates the relations of inclusion in which the area 40₂₅ identified by the identification information “first floor of Shibuya station”, the area 40₂₉ identified by the identification information “Shibuya station”, the area 40₁₈ identified by the identification information “around Shibuya station”, the area 40₁₉ identified by identification information “about 15 minutes from Shibuya station”, and the area 40₃₀ identified by identification information “close to stations on west side of Yamanote line” are included in that particular order on a one-to-one relation of inclusion.

The second determining unit 27A selects a single second set of partial information 41 from among a plurality of second sets of partial information 41 obtained by the disaggregating unit 25A.

Herein, the second determining unit 27A can select an arbitrary second set of partial information 41 from among a plurality of second sets of partial information 41 obtained by the disaggregating unit 25A. Alternatively, the second determining unit 27A can obtain a single second set of partial information from the input unit 14 via the obtaining unit 20A.

In the case when the second determining unit 27A obtains a single second set of partial information from the input unit 14 via the obtaining unit 20A; the output unit 28A of the information processing apparatus 12A displays, for example, a list of the second sets of partial information obtained by the disaggregating unit 25A. Moreover, on the display unit 16, the output unit 28A further displays instruction information that prompts selection of a single second set of partial information.

Then, the input unit 14 is operated and a single second set of partial information 41 is selected from a plurality of second sets of partial information 41 that is displayed. To enable this selection, it is possible to use a standard user interface technology such as the dropdown box that enables selection of a single item from among a plurality of items.

When the user operates the input unit 14 and selects a single second set of partial information from a plurality of second sets of partial information 41 that is displayed; the input unit 14 receives information indicating the selected second set of partial information and sends it to the obtaining unit 20A. Thus, the obtaining unit 20A receives the information indicating the selected second set of partial information from the input unit 14. Then, the second determining unit 27A reads the information indicating the selected second set of partial information, which is obtained by the obtaining unit 20A, and selects that single second set of partial information.

The first determining unit 26A determines, as a candidate area group, the relations of inclusion among at least some of the areas 40 included in the second set of partial information that is selected by the second determining unit 27A. Herein, the first determining unit 26A determines the candidate area group in an identical manner to the first determining unit 26 according to the first embodiment.

Then, in an identical manner to the output unit 28 according to the first embodiment; the output unit 28A outputs the candidate area group, which is determined by the first determining unit 26A, on the display unit 16. As a result, the candidate area group gets displayed on the display unit 16.

Herein, as described above, each second set of partial information 41 holds a relation of inclusion and indicates one-to-one relations of inclusion between the areas 40 having adjoining sizes. For that reason, the candidate area group extracted from the second set of partial information 41 by the first determining unit 26A also holds a relation of inclusion and indicates one-to-one relations of inclusion between the areas 40 having adjoining sizes.

Hence, in the second embodiment, on the display unit 16 is displayed the candidate area group which holds a relation of inclusion and indicates one-to-one relations of inclusion between the areas 40 having adjoining sizes.

Alternatively, from among a plurality of areas 40 defined in the second set of partial information that is determined by the second determining unit 27A, the first determining unit 26A can extract target areas 40 for display each of which has the closest size to one of a plurality of predetermined sizes; can set the relations of inclusion among the extracted areas 40 as the second set of partial information 41; and treat that second set of partial information 41 as the candidate area group.

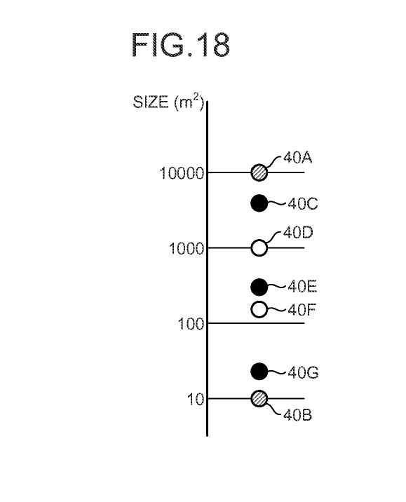

FIG. 18 is a schematic diagram illustrating a manner of extracting the relations of inclusion among at least some of the areas 40 defined in a second set of partial information 41.

As illustrated in FIG. 18, for example, from among a plurality of areas 40 defined in the second set of partial information 41 that is determined by the second determining unit 27A, the first determining unit 26A identifies the area 40 having the largest size and the area 40 having the smallest size. Then, the first determining unit 26A divides the range of sizes, which has the area 40 having the largest size as the upper limit and has the area 40 having the smallest size as the lower limit, into a plurality of levels of size. Subsequently, from among a plurality of areas 40 defined in the second set of partial information 41 that is determined by the second determining unit 27A, the first determining unit 26A extracts the areas 40 each being closest to one of the divided levels of size.

In the example illustrated in FIG. 18, regarding a plurality of areas 40 (an area 40A to an area 40G), the first determining unit 26A divides the areas 40, which range from the area 40 having the largest size (10000 m²) to the area 40 having the smallest size (10 m²), into three levels of size. Then, from the second set of partial information, the first determining unit 26A extracts the area 40D that is the closest area 40 to the level of size of 100 m²; extracts the area 40F that is the closest area 40 to the level of size of 1000 m²; and extracts the relations of inclusion of the extracted areas 40.

Alternatively, regarding a plurality of levels of size obtained by dividing a predetermined range of sizes, the first determining unit 26A can extract the closest area 40 to each level of size. Such a range of sizes can be set depending on, for example, the contents of the service provided by the information processing apparatus 12A. More particularly, the range of sizes can be between 50 m² or greater and 100 m² or smaller. In this case, the range of sizes can be stored in advance in the storage unit 18.

Given below is the explanation of a sequence of operations performed in the information processing apparatus 12A.

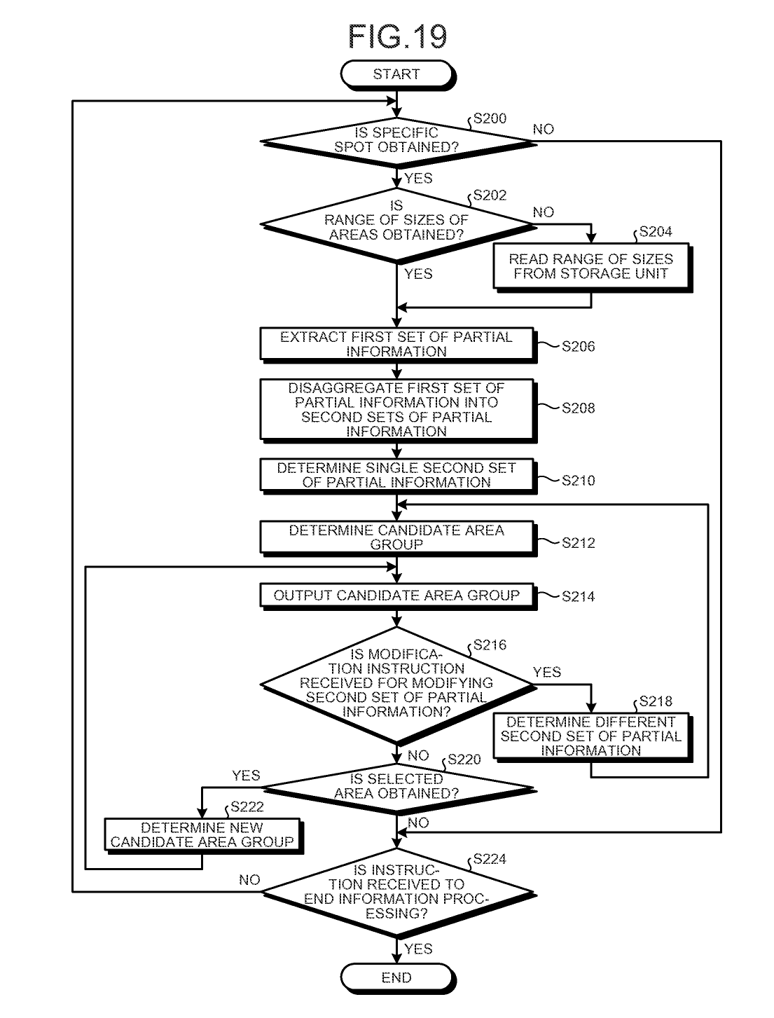

FIG. 19 is a flowchart for explaining the sequence of operations performed in the information processing apparatus 12A according to the second embodiment.

Firstly, the obtaining unit 20A determines whether or not a specific spot is received from the input unit 14 (Step S200). If it is determined that a specific spot is received from the input unit 14 (Yes at Step S200), then the system control proceeds to Step S202.

Subsequently, the obtaining unit 20A determines whether or not a range of sizes of the target areas 40 for display is obtained from the input unit 14 (Step S202). The obtaining unit 20A performs the determination at Step S202 by determining whether or not the smallest size and the largest size among the target areas 40 for display are obtained as the range of sizes from the input unit 14.

If it is determined that the range of sizes of the target areas 40 for display is obtained (Yes at Step S202), then the system control proceeds to Step S206. On the other hand, if it is determined that the range of sizes of the target areas 40 for display is not obtained (No at Step S202), then the system control proceeds to Step S204. In that case, the obtaining unit 20A reads the range of sizes of the target areas 40 for display that is stored in advance in the storage unit 18, and obtains the range of sizes (Step S204). Herein, in the storage unit 18 is stored the range of sizes that is obtained the previous time. Thus, the obtaining unit 20A can perform the operation at Step S204 by reading the range of sizes from the storage unit 18.

Subsequently, from the relationship information 50, the extracting unit 24A extracts a first set of partial information that indicates the relations of inclusion among the areas 40 which include the specific spot obtained by the obtaining unit 20A at Step S200 (Step S206).

Then, the disaggregating unit 25A disaggregates the first set of partial information, which has been extracted at Step S206, into a plurality of second sets of partial information (Step S208).

Then, from a plurality of second sets of partial information obtained at Step S208, the second determining unit 27A determines a single second set of partial information (Step S210).

Subsequently, from the second set of partial information determined either at Step S210 or at Step S218 (described later), the first determining unit 26A determines a candidate area group (Step S212). Then, the output unit 28A outputs the candidate area group, which is determined by the first determining unit 26A either at Step S212 or at Step S222 (described later), on the display unit 16 (Step S214). As a result of the operation performed at Step S214, the candidate area group gets displayed on the display unit 16.

Then, the obtaining unit 20A determines whether or not a modification instruction for modifying the second set of partial information is received from the input unit 14 (Step S216). Herein, the obtaining unit 20A can perform the determination at Step S216 in the following manner. For example, on the display unit 16, an instruction button can be displayed that enables issuing a modification instruction for modifying the second set of partial information. If the user operates the input unit 14 and selects the display area in which the instruction button is displayed, the input unit 14 can receive a signal representing a modification instruction for modifying the second set of partial information. Then, the obtaining unit 20A can determine whether or not the signal representing a modification instruction is received from the input unit 14.

If it is determined that a modification instruction for modifying the second set of partial information is received from the input unit 14 (Yes at Step S216), then the second determining unit 27A determines a different second set of partial information, which is different than the second set of partial information displayed previously on the display unit 16, from among the second sets of partial information obtained at Step S208 (Step S218). Then, the system control returns to Step S212.

On the other hand, if it is determined that no modification instruction is received from the input unit 14 (No at Step S216), then the system control proceeds to Step S220. Subsequently, the obtaining unit 20A determines whether or not a selected area is received from the input unit 14 (Step S220). If it is determined that a selected area is received from the input unit 14 (Yes at Step S220), then the system control proceeds to Step S222.

Then, the first determining unit 26A specifies the selected area, which is obtained at Step S220, as the new specific area; and determines, from the second set of partial information that is previously extracted either at Step S210 or at Step S218, the relations of inclusion among the areas 40 including the new specific area as the new candidate area group (Step S222). Then, the system control returns to Step S214.

Meanwhile, if it is determined that no specific spot is received from the input unit 14 (No at Step S200), then the system control proceeds to Step S224. Moreover, if it is determined that no selected area is received from the input unit 14 (No at Step S220), then the system control proceeds to Step S224.

Subsequently, the obtaining unit 20A determines whether or not to end the information processing (Step S224). Herein, the obtaining unit 20A performs the determination at Step S224 by determining whether or not information indicating the end of information processing is obtained from the input unit 14. In this case, if the user operates the input unit 14 and inputs the information indicating the end of information processing, then the input unit 14 can send the information indicating the end of information processing to the obtaining unit 20A. Subsequently, by determining whether or not the information indicating the end of information processing is obtained from the input unit 14, the obtaining unit 20A can perform the determination at Step S224. Alternatively, the obtaining unit 20A can perform the determination at Step S224 by determining whether or not a signal indicating termination of power supply to the information processing apparatus 12A is received as a result of an operation of a power switch (not illustrated) of the information processing apparatus 12A.

If it is determined not to end the information processing (No at Step S224), then the system control returns to Step S200. On the other hand, if it is determined to end the information processing (Yes at Step S224); then that marks the end of the present routine.

As a result of the abovementioned information processing in the information processing apparatus 12A, a candidate area group that represents the relations of inclusion regarding the user-specified specific spot gets displayed on the display unit 16 (or on the UI unit 15).

As described above, a second set of partial information 41 holds a relation of inclusion and indicates one-to-one relations of inclusion between the areas 40 having adjoining sizes. For that reason, the candidate area group extracted from the second set of partial information 41 by the first determining unit 26A also holds a relation of inclusion and indicates one-to-one relations of inclusion between the areas 40 having adjoining sizes.

Thus, in the second embodiment, on the display unit 16 is displayed the candidate area group that holds a relation of inclusion and indicates one-to-one relations of inclusion between the areas 40 having adjoining sizes.

As a result, the user can operate the input unit 14 and can easily enlarge or reduce the selected areas 40 in accordance with the one-to-one relations of inclusion of the areas 40 defined in the candidate area group that is displayed on the display unit 16.

Hence, in the information processing apparatus 12A according to the second embodiment, in addition to the effect achieved in the first embodiment, the areas 40 that are desired by the user can be provided in a natural view and in accordance with the relations of inclusion among the areas 40 and the sizes of the areas 40.

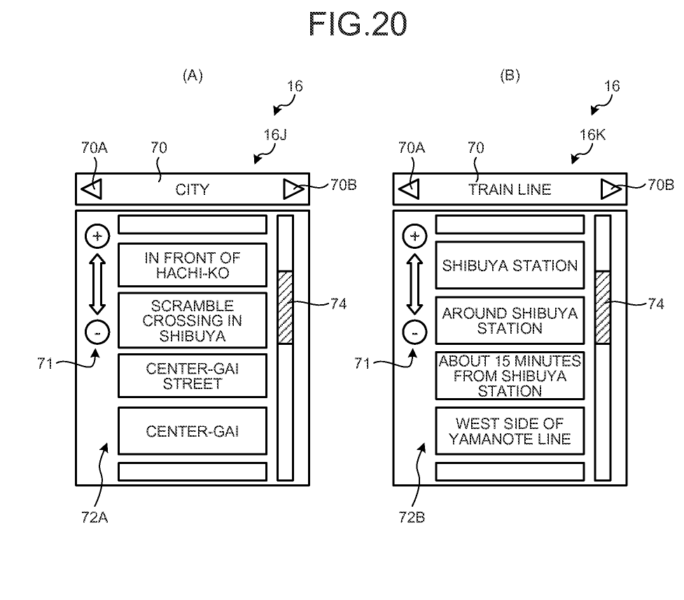

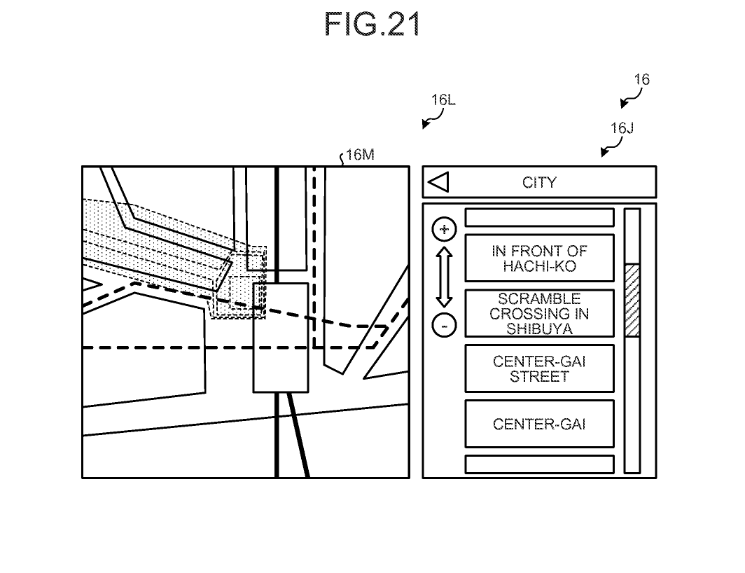

FIGS. 20 and 21 are schematic diagrams illustrating examples of display images that are displayed on the display unit 16 as a result of the information processing performed in the information processing apparatus 12A according to the second embodiment. Each of those display images is created by the output unit 28A.

For example, in the case when the second determining unit 27A determines the second set of partial information 41A illustrated in FIG. 16; the output unit 28A determines the relations of inclusion of at least some of the areas 40 in the second set of partial information 41A as the candidate area group. In this case, for example, the output unit 28A displays a display image 16J illustrated in (A) in FIG. 20 on the display unit 16.

The display image 16J includes an image 72A in which the names of the areas 40 defined in the second set of partial information 41A are listed according to the order of relations of inclusion defined in the second set of partial information 41A. Moreover, the display image 16J also includes a scroll button 74, which is used to scroll the list of names of the areas 40 in the vertical direction of the screen, and a slider 71, which is used to change the scale factor.

When the user operates the input unit 14 and changes the display position of the scroll button 74, it becomes possible to perform a scrolling display of the list of names displayed on the screen of the display unit 16. Moreover, when the user operates the input unit 14 and moves the slider 71, it becomes possible to input the range of sizes of the target areas 40 for display as described above.

The display image 16J further includes a display area 70, which contains a character image for identifying the second set of partial information 41A being currently displayed, and includes instruction buttons 70A and 70B, which are used to issue an instruction to switch the second set of partial information 41A being currently displayed to another second set of partial information 41. In (A) in FIG. 20, an image indicating “city” is displayed as the character image.

As the identification information that enables identification of the second set of partial information 41A being currently displayed, the display image 16J displays a character image illustrating character information for identifying the second set of partial information 41A. As a result, the second set of partial information 41A being currently displayed can be provided to the user in an easily recognizable manner.

Moreover, as the identification information that enables identification of the second set of partial information 41 determined by the second determining unit 27A (in (A) in FIG. 20, the second set of partial information 41A); the output unit 28A selects, from among the types included in the attributes of the areas 40 defined in that second set of partial information 41, the type having the highest multiplicity among the areas 40 as the display target. That is, the output unit 28A selects the type having the highest multiplicity as the identification information of the second set of partial information 41 to be displayed. Then, at the time of displaying the candidate area group of the second set of partial information 41 on the display unit 16, the output unit 28A also displays a character image of the type having the highest multiplicity as the identification information of the second set of partial information 41.

In the example illustrated in (A) in FIG. 20, a type “city” is displayed as a character image of the identification information of the second set of partial information 41.

When the user operates the input unit 14 and selects the instruction button 70A or the instruction button 70B; the input unit 14 sends, to the obtaining unit 20A, a signal that indicates a modification instruction for modifying the second set of partial information. As a result, in the information processing apparatus 12A, the second set of partial information is modified. Then, for example, the output unit 28A displays a display image 16K illustrated in (B) in FIG. 20 on the display unit 16.

The display image 16K includes an image 72B in which the names of the areas 40 defined in a second set of partial information 41 that is different than the second set of partial information 41A, which is displayed in (A) in FIG. 20, are listed according to the order of relations of inclusion defined in that second set of partial information 41A. Moreover, the display image 16K also includes the scroll button 74, which is used to scroll the list of names of the areas 40 in the vertical direction of the screen, and the slider 71, which is used to change the scale factor.

The display image 16K further includes the display area 70, which contains a character image for identifying the second set of partial information 41 being currently displayed, and includes the instruction buttons 70A and 70B, which are used to issue an instruction to switch the second set of partial information 41 being currently displayed to another second set of partial information 41. In (B) in FIG. 20, an image indicating “train line” is displayed as the character image.

Meanwhile, a display image that is displayed on the display unit 16 can be an image illustrated as a simplified sketch drawing.

FIG. 21 is a schematic diagram illustrating another example of the display image.

As illustrated in FIG. 21, on the display unit 16, the output unit 28A can display a display image 16M in which a sketch drawing of simplified geographical shapes of the areas 40 defined in the candidate area group is illustrated in a display form indicating the relations of inclusion among the areas 40. Alternatively, on the display unit 16, the output unit 28A can display a display image 16L in which the display image 16M is displayed alongside the display image 16J (also see (A) in FIG. 20) that illustrates the relations of inclusion among the areas 40 in the form of a list of character images.

In this way, in the information processing apparatus 12A according to the second embodiment, in addition to the effect achieved in the first embodiment, the areas 40 that are desired by the user can be provided in accordance with the relations of inclusion among the areas 40 and in accordance with the sizes of the areas 40.

### Third Embodiment

In a third embodiment, some of the functions of the information processing apparatus 12 according to the first embodiment are provided in a server device; and a candidate area group is displayed on a display unit of an information processing terminal that is connected to the server device via a network.

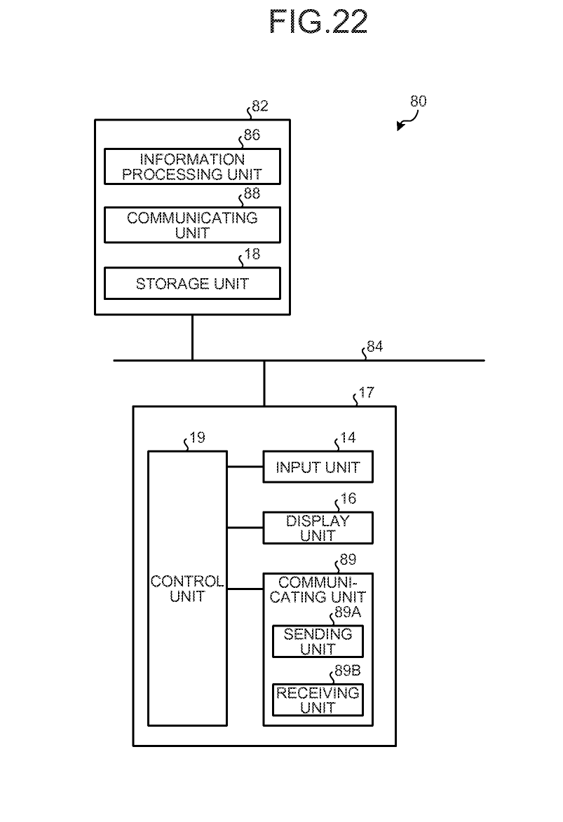

FIG. 22 is a schematic diagram illustrating an information processing system 80 according to the third embodiment. As illustrated in FIG. 22, the information processing system 80 includes a server device 82 and an information processing terminal 17 that are connected to each other via a network 84.

The server device 82 is a computer that includes a CPU, a ROM, and a RAM. Moreover, the server device 82 includes an information processing unit 86, a communicating unit 88, and the storage unit 18.

Herein, the storage unit 18 is identical to the storage unit 18 of the information processing apparatus 12 according to the first embodiment (see FIG. 1). The communicating unit 88 communicates a variety of information with the information processing terminal 17 via the network 84.

The information processing unit 86 includes (although not illustrated in FIG. 22) the obtaining unit 20, the extracting unit 24, the first determining unit 26, and the output unit 28, which are the constituent elements of the information processing apparatus 12 according to the first embodiment (see FIG. 1). Moreover, in the information processing unit 86, the obtaining unit 20 obtains a variety of information from the information processing terminal 17. Apart from that, the obtaining unit 20 is identical to the obtaining unit 20 of the information processing apparatus 12. Furthermore, in the information processing unit 86, the output unit 28 outputs a variety of information to the information processing terminal 17. Apart from that, the output unit 28 is identical to the output unit 28 of the information processing apparatus 12.

The information processing terminal 17 is a computer that includes a CPU, a ROM, and a RAM. Moreover, the information processing terminal 17 is, for example, a portable information processing apparatus.

The information processing terminal 17 includes the input unit 14, the display unit 16, a control unit 19, and a communicating unit 89. Herein, the input unit 14 and the display unit 16 are identical to the input unit 14 and the display unit 16 according to the first embodiment. The control unit 19 controls the information processing terminal 17. The communicating unit 89 sends a variety of information to and receives a variety of information from the server device 82 via the network 84. The communicating unit 89 includes a sending unit 89A and a receiving unit 89B. The sending unit 89A sends a variety of information to the server device 82 via the network 84. The receiving unit 89B receives a variety of information from the server device 82 via the network 84.

Given below is the explanation of the information processing performed in the information processing terminal 17.

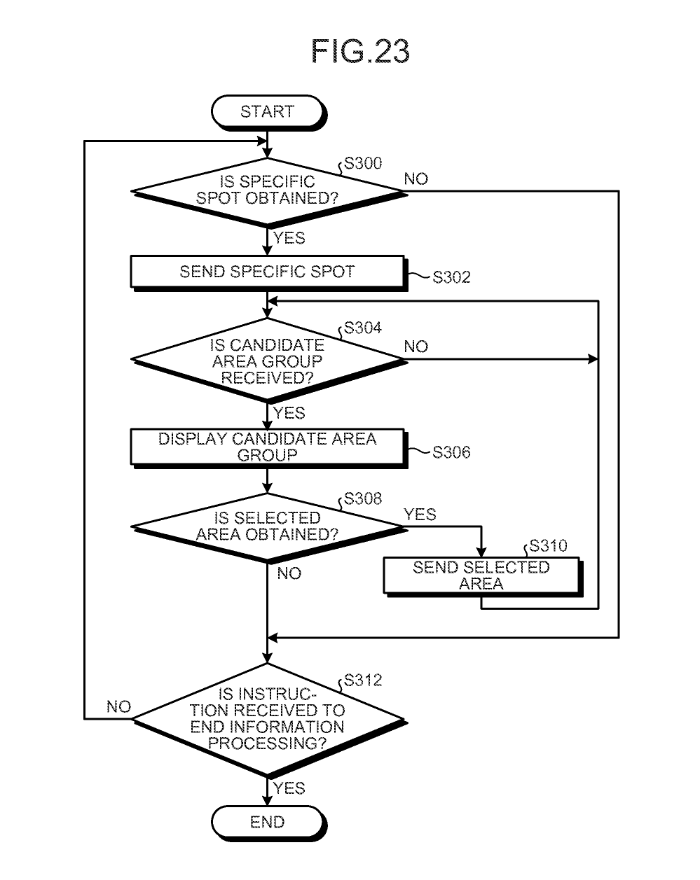

FIG. 23 is a flowchart for explaining a sequence of operations performed by the control unit 19 of the information processing terminal 17.

Firstly, the control unit 19 determines whether or not a specific spot is received from the input unit 14 (Step S300). If it is determined that a specific spot is received from the input unit 14 (Yes at Step S300), then the system control proceeds to Step S302.

Subsequently, the sending unit 89A sends the specific spot, which is obtained at Step S300, to the server device 82 via the network 84 (Step S302).

Then, the receiving unit 89B determines whether or not a candidate area group is received from the server device 82 (Step S304). Until it is determined that a candidate area group is received from the server device 82 (Yes at Step S304), the receiving unit 89B repeats determining that no candidate area group is received from the server device 82 (No at Step S304).

Once it is determined that a candidate area group is received from the server device 82 (Yes at Step S304), the system control proceeds to Step S306. Then, the control unit 19 displays the candidate area group, which is received at Step S304, on the display unit 16 (Step S306). Herein, at Step S306, the candidate area group is displayed on the display unit 16 in an identical manner to that described in the first embodiment.

Subsequently, the control unit 19 determines whether or not a selected area is received from the input unit 14 (Step S308). If it is determined that a selected area is received from the input unit 14 (Yes at Step S308), then the system control proceeds to Step S310.

Subsequently, the sending unit 89A sends the selected area, which is obtained at Step S308, from the information processing terminal 17 to the server device 82 via the network 84 (Step S310). The system control then returns to Step S304.

Meanwhile, if it is determined that no selected area is received from the input unit 14 (No at Step S308), then the system control proceeds to Step S312. Subsequently, the control unit 19 determines whether or not to end the information processing (Step S312). Herein, the determination at Step S312 is performed in an identical to Step S112 (see FIG. 6) described above.

If it is determined not to end the information processing (No at Step S312), then the system control returns to Step S300. On the other hand, if it is determined to end the information processing (Yes at Step S312); then that marks the end of the present routine.

Given below is the explanation of a sequence of operations performed in the server device 82.

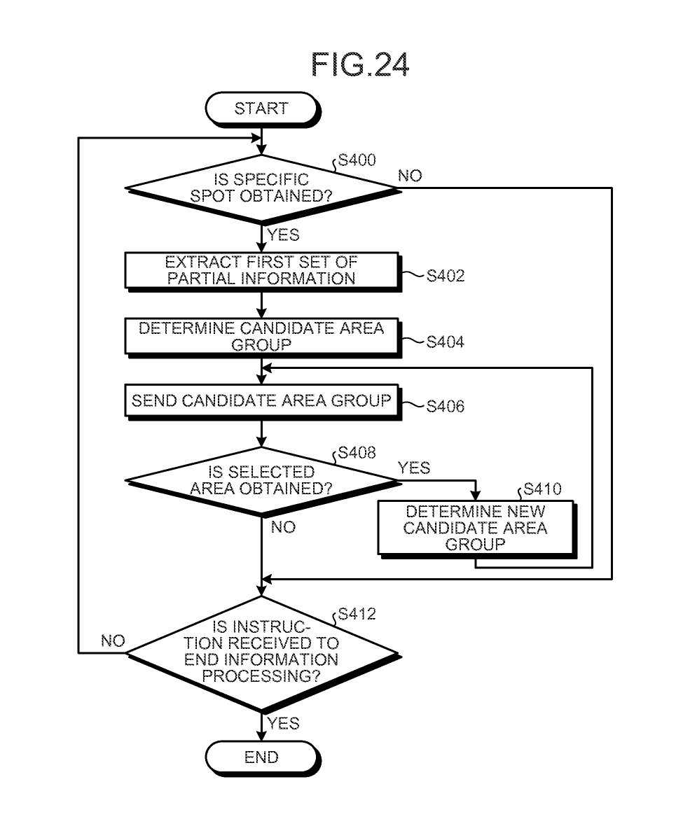

FIG. 24 is a flowchart for explaining the sequence of operations performed in the server device 82.

Firstly, the information processing unit 86 determines whether or not a specific spot is received from the information processing terminal 17 (Step S400). If it is determined that a specific spot is received from the information processing terminal 17 (Yes at Step S400), then the system control proceeds to Step S402.

Subsequently, from the relationship information 50 stored in the storage unit 18, the information processing unit 86 extracts the first set of partial information that indicates the relations of inclusion among the areas 40 which include the specific spot obtained at Step S400 (Step S402).

Subsequently, the information processing unit 86 determines, as a candidate area group, the relations of inclusion among at least some of the areas 40 included in the first set of partial information that is extracted at Step S402 (Step S404). Then, to the information processing terminal 17, the communicating unit 88 sends the candidate area group that is determined by the information processing unit 86 either at Step S404 or at Step S410 (described later) (Step S406).

Subsequently, the communicating unit 88 determines whether or not a selected area is obtained from the information processing terminal 17 (Step S408). If it is determined that a selected area is obtained from the information processing terminal 17 (Yes at Step S408), then the information processing unit 86 specifies the selected area, which is obtained at Step S408, as the new specific area; and determines, as the new candidate area group, at least some relations of inclusion including the new specific area from the first set of partial information extracted at Step S402 (Step S410). Then, the system control returns to Step S406.

Meanwhile, if it is determined that no specific spot is received from the information processing terminal 17 (No at Step S400), then the system control proceeds to Step S412. Moreover, if it is determined that no selected area is obtained from the information processing terminal 17 (No at Step S408), then the system control proceeds to Step S412.

Then, the information processing unit 86 determines whether or not to end the information processing (Step S412). Herein, the information processing unit 86 performs the determination at Step S412 by, for example, determining whether or not information indicating the end of information processing is obtained from the information processing terminal 17. In this case, in the information processing terminal 17, when it is determined to end the information processing at Step S312 (see FIG. 23) (Yes at Step S312); the information indicating the end of information processing can be sent to the server device 82.

If it is determined not to end the information processing (No at Step S412), then the system control returns to Step S400. On the other hand, if it is determined to end the information processing (Yes at Step S412); then that marks the end of the present routine.

As described above, in the third embodiment, the information processing terminal 17 sends the specific spot, which is input by the user, to the server device 82. On the other hand, the information processing terminal 17 receives the candidate area group from the server device 82 and displays it on the display unit 16.

For that reason, in the information processing terminal 17, the relations of inclusion among the areas 40 that include the specific spot, which is received by the input unit 14, get displayed on the display unit 16.

Hence, in an identical manner to the embodiments described above, even in the information processing terminal 17 according to the third embodiment, it becomes possible to provide information that enables easy understanding of the geographical relations of inclusion of the specific spot.

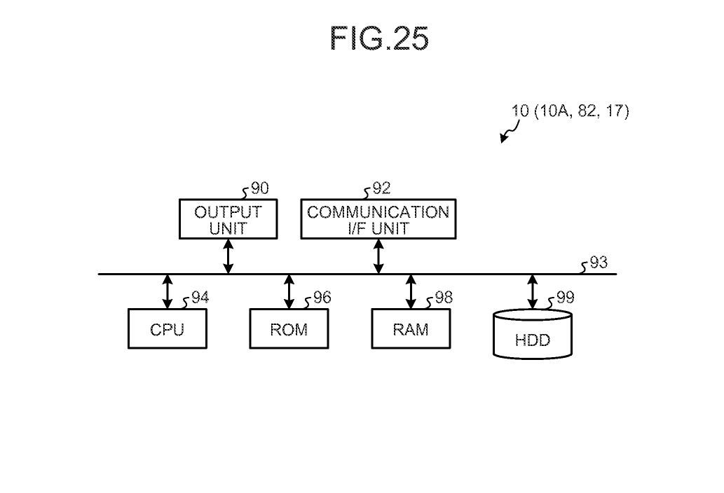

Given below is the explanation about a hardware configuration of the information processing system 10 according to the first embodiment, the information processing system 10A according to the second embodiment, and the server device 82 and the information processing terminal 17 according to the third embodiment. FIG. 25 is a block diagram illustrating a hardware configuration example of the information processing system 10 according to the first embodiment, the information processing system 10A according to the second embodiment, and the server device 82 and the information processing terminal 17 according to the third embodiment.

Herein, each of the information processing system 10 according to the first embodiment, the information processing system 10A according to the second embodiment, the server device 82 according to the third embodiment, and the information processing terminal 17 according to the third embodiment has the hardware configuration of a commonly-used computer in which an output unit 90, a communication I/F unit 92, a CPU 94, a ROM 96, a RAM 98, and a hard disk drive (HDD) 99 are connected to each other via a bus 93.

The CPU 94 is a processor that controls the overall operations of the information processing apparatus 12 in the information processing system 10; controls the overall operations of the information processing apparatus 12A in the information processing system 10A; controls the overall operations of the server device 82; and controls the overall operations of the information processing terminal 17. The RAM 98 is used to store data that is required during various operations performed by the CPU 94. The ROM 96 is used to store computer programs that are executed to implement the operations performed by the CPU 94. The HDD 99 is used to store the data that is stored in each storage unit 18 described above. The communication I/F unit 92 is an interface that establishes connection with an external device or an external terminal via a communication line, and sends data to or receives data from the external device or the external terminal. The output unit 90 corresponds to the display unit 16 described above.

The computer programs that are executed for performing the abovementioned information processing in the information processing apparatus 12 in the information processing system 10 according to the first embodiment, in the information processing apparatus 12A in the information processing system 10A according to the second embodiment, and in the server device 82 and the information processing terminal 17 according to the third embodiment are stored in advance in the ROM 96 and provided as a computer program product.

Alternatively, the computer programs that are executed for performing the abovementioned information processing in the information processing apparatus 12 in the information processing system 10 according to the first embodiment, in the information processing apparatus 12A in the information processing system 10A according to the second embodiment, and in the server device 82 and the information processing terminal 17 according to the third embodiment can be recorded in the form of installable or executable files in a computer-readable recording medium such as a compact disk read only memory (CD-ROM), a flexible disk (FD), a compact disk readable (CD-R), or a digital versatile disk (DVD) and provided as a computer program product.

Still alternatively, the computer programs that are executed for performing the abovementioned information processing in the information processing apparatus 12 in the information processing system 10 according to the first embodiment, in the information processing apparatus 12A in the information processing system 10A according to the second embodiment, and in the server device 82 and the information processing terminal 17 according to the third embodiment can be saved as downloadable files on a computer connected to the Internet as a computer program product or can be made available for distribution through a network such as the Internet.

As a result of executing the computer programs for performing the abovementioned information processing in the information processing apparatus 12 in the information processing system 10 according to the first embodiment, in the information processing apparatus 12A in the information processing system 10A according to the second embodiment, and in the server device 82 and the information processing terminal 17 according to the third embodiment; each of the abovementioned constituent elements is generated in a main memory device.

Meanwhile, the variety of information stored in the HDD 99, that is, the variety of information stored in the storage unit 18 can also be stored in an external device (such as a server). In this case, the configuration can be such that the external device and the CPU 94 are connected via a network.

According to at least one embodiment described above, it is possible to provide information which enables easy understanding of the geographical relations of inclusion of the specific spot.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an obtaining unit configured to obtain a specific spot;
an extracting unit configured to extract a first set of partial information from relationship information that indicates geographical relations of inclusion among a plurality of geographical areas, the first set of partial information indicating relations of inclusion among areas that include the specific spot;
a first determining unit configured to determine, as a candidate area group to be output, at least one of the relations of inclusion among areas included in the first set of partial information; and
an output unit configured to output the candidate area group.

2. The apparatus according to claim 1, further comprising:
a disaggregating unit configured to disaggregate the first set of partial information into a plurality of second sets of partial information each of which indicates a one-to-one relation of inclusion between areas having adjoining sizes; and
a second determining unit configured to determine a single second set of partial information from among the plurality of second sets of partial information, wherein
as the candidate area group, the first determining unit determines at least one of the relations of inclusion among areas included in the single second set of partial information.

3. The apparatus according to claim 1, wherein the first determining unit specifies a single area in the first set of partial information as a specific area, and determines, as the candidate area group, at least a relation of inclusion between the specific area and an area in the first set of partial information that is geographically included in the specific area and that has a next smaller size to a size of the specific area and a relation of inclusion between the specific area and an area in the first set of partial information that geographically includes the specific area and that has a next larger size to the size of the specific area.

4. The apparatus according to claim 3, wherein
as a selected area, the obtaining unit further obtains, from a user, a single area included in the candidate area group that has been output, and
the first determining unit specifies the selected area as a new specific area, and determines, as the candidate area group, at least a relation of inclusion between the new specific area and an area in the first set of partial information that is geographically included in the new specific area and that has a next smaller size to the size of the new specific area and a relation of inclusion between the new specific area and an area in the first set of partial information that geographically includes the new specific area and that has a next larger size to the size of the new specific area.

5. The apparatus according to claim 1, wherein the relationship information has a digraph data structure illustrated by a graph theory in which areas are considered as nodes and are linked by directed edges having directions in accordance with geographical relations of inclusion among areas.

6. The apparatus according to claim 1, wherein the area has at least one of a name of the area and a geographical shape of the area.

7. The apparatus according to claim 6, wherein the geographical shape is in a form of a sketch drawing.

8. The apparatus according to claim 1, wherein
the area has a geographical area type, and
the output unit further outputs an area type having a highest multiplicity of area types in the candidate area group.

9. The apparatus according to claim 2, wherein the disaggregating unit combines at least some of the plurality of second sets of partial information to generate a new second set of partial information.

10. An information processing terminal comprising:
a sending unit configured to send a specific spot to a server device that is connected via a network;
a receiving unit configured to receive, from the server device, at least one of relations of inclusion among areas defined in a first set of partial information, as a candidate area group to be output, the first set of partial information being extracted from relationship information indicating geographical relations of inclusion among a plurality of geographical areas, the first set of partial information indicating relations of inclusions among areas that include the specific spot; and
a control unit configured to display the candidate area group on a display unit.

11. The terminal according to claim 10, further comprising an input unit configured to receive, from a user, a single area included in the candidate area group as a selected area, wherein
the sending unit sends the selected area to the server device, and
the receiving unit further receives a new candidate area group corresponding to the selected area from the server device.

12. A computer program product comprising a computer-readable medium containing a program executed by a computer, the program causing the computer to execute:
obtaining a specific spot;
extracting a first set of partial information from relationship information that indicates geographical relations of inclusion among a plurality of geographical areas, the first set of partial information indicating relations of inclusion among areas that include the specific spot;
determining, as a candidate area group to be output, at least one of the relations of inclusion among areas included in the first set of partial information; and
outputting the candidate area group.

13. An information processing method comprising:
obtaining a specific spot;
extracting a first set of partial information from relationship information that indicates geographical relations of inclusion among a plurality of geographical areas, the first set of partial information indicating relations of inclusion among areas that include the specific spot;
determining, as a candidate area group to be output, at least one of the relations of inclusion among areas included in the first set of partial information; and
outputting the candidate area group.

14. A computer program product comprising a computer-readable medium containing a program executed by a computer, the program causing the computer to execute:
sending a specific spot to a server device that is connected via a network;
receiving, from the server device, at least one of relations of inclusion among areas defined in a first set of partial information, as a candidate area group to be output, the first set of partial information being extracted from relationship information indicating geographical relations of inclusion among a plurality of geographical areas, the first set of partial information indicating relations of inclusions among areas that include the specific spot; and
a control unit configured to display the candidate area group on a display unit.

15. An information processing method comprising:
sending a specific spot to a server device which is connected via a network;
receiving, from the server device, at least one of relations of inclusion among areas defined in a first set of partial information, which is extracted from relationship information indicating geographical relations of inclusion among a plurality of geographical areas and which indicates relations of inclusions among areas that include the specific spot, as a candidate area group to be output; and
displaying the candidate area group on a display unit.
